(19) United States
(12) Patent Application Publication
(10) Pub. No.: US 2024/0357062 A1
(43) Pub. Date: Oct. 24, 2024

(54) MONITORING DEVICE, MONITORING SYSTEM, STORAGE MEDIUM AND MONITORING METHOD

(71) Applicant: Mitsubishi Electric Corporation, Tokyo (JP)

(72) Inventors: Takeshi NIIKAWA, Tokyo (JP); Kaoru NISHIYAMA, Tokyo (JP); Satoshi SHIGA, Tokyo (JP); Seika KUDO, Tokyo (JP); Daichi MAMADA, Tokyo (JP); Thibaud GENTIL, Tokyo (JP)

(73) Assignee: Mitsubishi Electric Corporation, Tokyo (JP)

(21) Appl. No.: 18/683,783

(22) PCT Filed: Sep. 22, 2021
(86) PCT No.: PCT/JP2021/034826

§ 371 Date: Feb. 15, 2024

(51) Int. Cl. H04N 7/18; G06V 20/40; G06V 20/52; G06V 20/60; G06V 40/10; G08B 13/196; H04N 23/667

(52) U.S. Cl. CPC H04N 7/183; G06V 20/40; G06V 20/52; G06V 20/60; G06V 40/10; G08B 13/19608; G08B 13/19613; G08B 13/19669; H04N 23/667

(57) ABSTRACT

To provide a monitoring system that can improve convenience of a service for watching baggage. A monitoring system comprises a camera provided in a store, a personal terminal carried by a user of the store, and a monitoring device that receives a video of the store photographed by the camera and communicates with the personal terminal. The monitoring device sets, based on a command from the personal terminal to start monitoring, a monitoring mode for watching a thing, sets, as a monitoring target, an image of a thing designated from the personal terminal of the user in a picture of the camera or a region of a picture designated from the personal terminal in the picture of the camera, and, when the monitoring mode is set, detects an abnormality when it is detected that the target object reflected in the video photographed by the camera has moved.

### TECHNICAL FIELD

The present disclosure relates to a monitoring device, a monitoring system, a program, and a monitoring method.

### BACKGROUND ART

PTL 1 discloses an order terminal for self-order provided in a store such as a restaurant. A user of the store designates, with the order terminal, baggage on a table or a seat. The order terminal can watch, based on a video of a camera, whether the designated baggage has been moved.

### CITATION LIST

### Patent Literature

[PTL 1] JP 2016-173840 A

### SUMMARY OF THE INVENTION

### Problem to be Solved by the Invention

However, the order terminal described in PTL 1 is installed on the table of the store. When the user has moved away from the table, the user cannot designate baggage that the user desires to be watched. Therefore, convenience of a service for watching baggage is deteriorated.

The present disclosure has been devised in order to solve the problems described above. An object of the present disclosure is to provide a monitoring device, a monitoring system, a program, and a monitoring method that can improve convenience of a service for watching baggage.

### Means for Solving the Problems

A monitoring device according to the present disclosure is a monitoring device that receives, from a camera provided in a store, a video of the store, which is continuous pictures photographed by the camera, and communicates with a personal terminal carried by a user of the store, the monitoring device comprising: a mode setting unit that sets, based on a command from the personal terminal to start monitoring, a monitoring mode for watching a thing; a target setting unit that sets, as a monitoring target, an image of a target object of monitoring designated from the personal terminal among the pictures photographed by the camera or a region of a picture reflecting the target object of monitoring among the pictures photographed by the camera, the region being a region of a picture designated from the personal terminal of the user; and a movement detecting unit that, when the monitoring mode is set by the mode setting unit, detects an abnormality when it is detected that the target object reflected in the video photographed by the camera has moved.

A monitoring system according to the present disclosure comprises: a camera provided in a store; a personal terminal carried by a user of the store; and a monitoring device that receives a video of the store, which is continuous pictures photographed by the camera, and communicates with the personal terminal. The monitoring device sets, based on a command from the personal terminal to start monitoring, a monitoring mode for watching a thing, sets, as a monitoring target, an image of a target object of monitoring designated from the personal terminal among the pictures photographed by the camera or a region of a picture reflecting the target object of monitoring among the pictures photographed by the camera, the region being a region of a picture designated from the personal terminal of the user, and, when the monitoring mode is set, detects an abnormality when it is detected that the target object reflected in the video photographed by the camera has moved.

A program according to the present disclosure causes a computer, which receives, from a camera provided in a store, a video of the store, which is continuous pictures photographed by the camera, and communicates with a personal terminal carried by a user of the store, to execute: a mode setting step for setting, based on a command from the personal terminal to start monitoring, a monitoring mode for watching a thing; a thing detecting step for setting, as a monitoring target, an image of a target object of monitoring designated from the personal terminal among the pictures photographed by the camera provided in the store or a region of a picture reflecting the target object of monitoring among the pictures photographed by the camera, the region being a region of a picture designated from the personal terminal of the user; and a movement detecting step for, when the monitoring mode is set by the mode setting step, detecting an abnormality when it is detected that the target object reflected in the video photographed by the camera has moved.

A monitoring method according to the present disclosure comprises: a mode setting step for setting, based on a command from a personal terminal carried by a user of a store to start monitoring, a monitoring mode for watching a thing; a thing detecting step for setting, as a monitoring target, an image of a target object of monitoring designated from the personal terminal among the pictures photographed by a camera or a region of a picture reflecting the target object of monitoring among the pictures photographed by the camera, the region being a region of a picture designated from the personal terminal of the user; and a movement detecting step, performed after the thing detecting step, for, when the monitoring mode is set by the mode setting step, detecting an abnormality when it is detected that the target object reflected in the video photographed by the camera has moved.

### Advantageous Effects of the Invention

According to the present disclosure, a monitoring target to be watched according to a command from a personal terminal of a user is set. Therefore, it is possible to improve convenience of a service for monitoring a baggage.

### BRIEF DESCRIPTION OF THE DRAWINGS

FIG. 1 is a diagram illustrating an overview of a store to which a monitoring system in a first embodiment is applied.

FIG. 2 is a diagram illustrating an overview of an operation performed by the monitoring system in the first embodiment.

FIG. 3 is a block diagram of the monitoring system in the first embodiment.

FIG. 4 is a flowchart for explaining an overview of an operation of a monitoring system in the first embodiment.

FIG. 5 is a hardware configuration diagram of a monitoring device of the monitoring system in the first embodiment.

FIG. 6 is a block diagram of a first modification of the monitoring system in the first embodiment.

FIG. 7 is a flowchart for explaining an overview of an operation of the first modification of the monitoring system in the first embodiment.

FIG. 8 is a block diagram of a second modification of the monitoring system in the first embodiment.

FIG. 9 is a flowchart for explaining an overview of an operation of the second modification of the monitoring system in the first embodiment.

FIG. 10 is a block diagram of a third modification of the monitoring system in the first embodiment.

FIG. 11 is a flowchart for explaining an overview of an operation of the third modification of the monitoring system in the first embodiment.

FIG. 12 is a block diagram of a fourth modification of the monitoring system in the first embodiment.

FIG. 13 is a flowchart for explaining an overview of an operation of the fourth modification of the monitoring system in the first embodiment.

FIG. 14 is a block diagram of a fifth modification of the monitoring system in the first embodiment.

FIG. 15 is a flowchart for explaining an overview of an operation of the fifth modification of the monitoring system in the first embodiment.

FIG. 16 is a diagram illustrating a target object before being applied with a monitoring system in a second embodiment.

FIG. 17 is a diagram illustrating a covering body of the monitoring system in the second embodiment.

FIG. 18 is a diagram illustrating a main part of the covering body of the monitoring system in the second embodiment.

FIG. 19 is a block diagram of the monitoring system in the second embodiment.

FIG. 20 is a flowchart for explaining an overview of an operation of the monitoring system in the second embodiment.

FIG. 21 is a diagram illustrating a monitoring tag of the monitoring system in a third embodiment.

FIG. 22 is a diagram illustrating monitoring tags of the monitoring system in the third embodiment.

FIG. 23 is a diagram illustrating flickering patterns of lights emitted by monitoring tags of the monitoring system in the third embodiment.

FIG. 24 is a block diagram of the monitoring system in the third embodiment.

FIG. 25 is a flowchart for explaining an overview of an operation of the monitoring system in the third embodiment.

FIG. 26 is a flowchart for explaining an overview of an operation of a first modification of the monitoring system in the third embodiment.

FIG. 27 is a diagram illustrating a monitoring tag of a second modification of the monitoring system in the third embodiment.

FIG. 28 is a flowchart for explaining an overview of an operation of the second modification of the monitoring system in the third embodiment.

FIG. 29 is a diagram illustrating a monitoring tag of a third modification of the monitoring system in the third embodiment.

FIG. 30 is a block diagram of the third modification of the monitoring system in the third embodiment.

FIG. 31 is a flowchart for explaining an overview of an operation of the third modification of the monitoring system in the third embodiment.

FIG. 32 is a diagram illustrating a monitoring tag of a fourth modification of the monitoring system in the third embodiment.

FIG. 33 is a block diagram of the fourth modification of the monitoring system in the third embodiment.

FIG. 34 is a flowchart for explaining an overview of an operation of the fourth modification of the monitoring system in the third embodiment.

FIG. 35 is a diagram illustrating a desk of a monitoring system in a fourth embodiment.

FIG. 36 is a block diagram of the monitoring system in the fourth embodiment.

FIG. 37 is a flowchart for explaining an overview of an operation of the monitoring system in the fourth embodiment.

FIG. 38 is a diagram illustrating a desk of a first modification of the monitoring system in the fourth embodiment.

FIG. 39 is a flowchart for explaining an overview of an operation of the first modification of the monitoring system in the fourth embodiment.

FIG. 40 is a flowchart for explaining an overview of an operation of a second modification of the monitoring system in the fourth embodiment.

FIG. 41 is a diagram illustrating an example of a pattern of the desk of the monitoring system in the fourth embodiment.

FIG. 42 is a flowchart for explaining an overview of an operation of a third modification of the monitoring system in the fourth embodiment.

FIG. 43 is a flowchart for explaining an overview of an operation of a fourth modification of the monitoring system in the fourth embodiment.

FIG. 44 is a block diagram of a monitoring system in a fifth embodiment.

FIG. 45 is a flowchart for explaining an overview of an operation of the monitoring system in the fifth embodiment.

FIG. 46 is a flowchart for explaining an overview of an operation of a modification of the monitoring system in the fifth embodiment.

FIG. 47 is a block diagram of a monitoring system in a sixth embodiment.

FIG. 48 is a flowchart for explaining an overview of an operation of the monitoring system in the sixth embodiment.

FIG. 49 is a block diagram of a monitoring system in a seventh embodiment.

FIG. 50 is a flowchart for explaining an overview of an operation of the monitoring system in the seventh embodiment.

### DESCRIPTION OF EMBODIMENTS

Modes for carrying out the present disclosure are explained with reference to the accompanying drawings. Note that, in the figures, the same or equivalent portions are denoted by the same reference numerals and signs. Redundant explanation of the portions is simplified or omitted as appropriate.

### First Embodiment

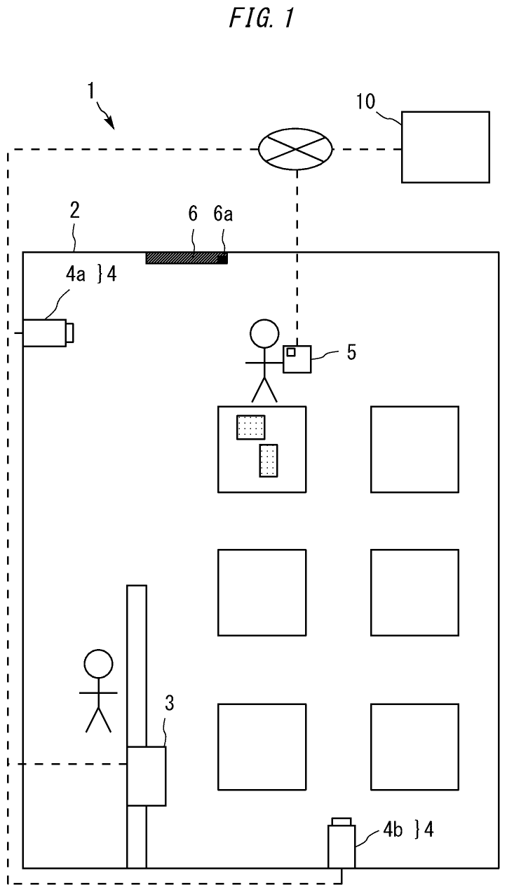

FIG. 1 is a diagram illustrating an overview of a store to which a monitoring system in a first embodiment is applied.

In FIG. 1, a monitoring system 1 provides a baggage monitoring service, which is a service for watching baggage of a user. The monitoring system 1 is introduced into a store 2. For example, the store 2 is a store such as a share office or a cafe. For example, in the store 2, a user occupies a desk of the store and performs work such as a job or study. In the store 2, a store terminal 3, a plurality of cameras 4, and a posting body 6 are provided.

For example, the store terminal 3 is a personal computer. The store terminal 3 can start a store application of a baggage monitoring service. For example, the store terminal 3 is provided at an employee counter of the store 2. Note that the store terminal 3 may be equipment such as a tablet-type portable terminal. The plurality of cameras 4 are security cameras of the store 2. Each of the plurality of cameras 4 can photograph a video of the inside of the store 2. The video is treated as continuous pictures. The posting body 6 is a poster printed to indicate that the monitoring system 1 is introduced into the store 2 and the baggage monitoring service is performed. The posting body 6 is posted in the store 2. A posting two-dimensional code 6a is displayed on the posting body 6.

For example, the personal terminal 5 is a smartphone-type portable terminal. The personal terminal 5 is carried by the user of the store 2. The personal terminal 5 can start a personal application for using the baggage monitoring service.

A monitoring device 10 is provided in a building different from the store 2. The monitoring device 10 can communicate with the store terminal 3, the plurality of cameras 4, and the personal terminal 5 via a network.

A store use screen, which is a store-side interface screen, of the baggage monitoring service is displayed on the store terminal 3 based on information received from the monitoring device 10. An employee of the store 2 watches the store use screen.

When using the baggage monitoring service, the user of the store 2 accesses the monitoring device 10 from the personal terminal 5. The monitoring device 10 causes a screen of the personal terminal 5 to display a use screen, which is a personal interface screen, of the baggage monitoring service. The user uses the baggage monitoring service by performing operation such as operation for checking the use screen displayed on the personal terminal 5 and operation for inputting information to a designated field in the use screen.

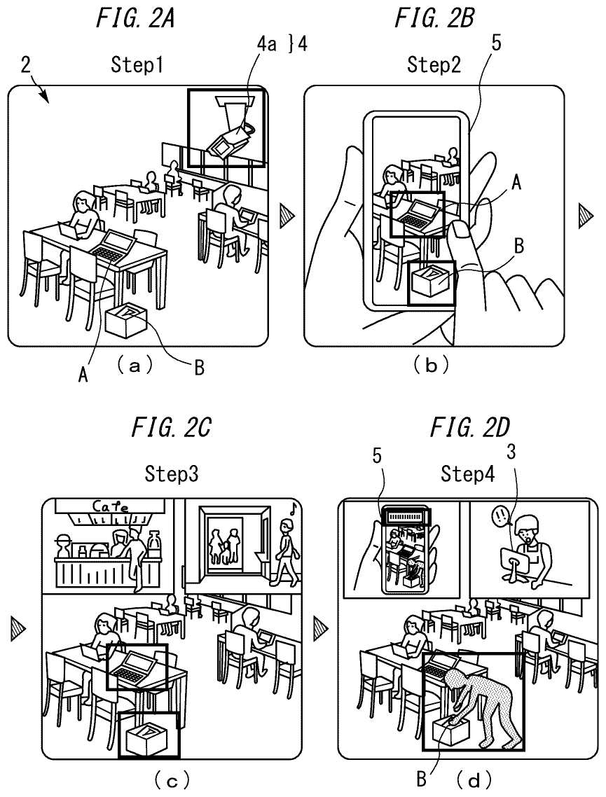

Subsequently, an operation performed in the monitoring system 1 is explained with reference to FIG. 2.

FIG. 2 is a diagram illustrating an overview of an operation performed by the monitoring system in the first embodiment.

(a) to (d) of FIG. 2 respectively illustrate situations that occur when the baggage monitoring service is used.

(a) of FIG. 2 illustrates “Step 1” in using the baggage monitoring service. A thing A and a thing B are properties of the user. A camera 4a among the plurality of cameras 4 photographs the thing A and the thing B. When using the baggage monitoring service, the user inputs information for identifying the store 2 on the use screen displayed on the personal terminal 5. A plurality of videos photographed by the plurality of cameras 4 in the store 2 are respectively displayed on the use screen. The user selects the video of the camera 4a.

As “Step 2” in using the baggage monitoring service, (b) of FIG. 2 illustrates the use screen of the personal terminal 5 on which the video of the camera 4a is displayed. The user designates the thing A and the thing B respectively as target objects of monitoring on the use screen. Specifically, for example, the user designates, with operation such as swipe on a screen, regions where the thing A and the thing B are displayed in the use screen. At this time, the user designates regions respectively including the thing A and the thing B, which are target objects. Note that, for example, the user may designate the thing A and the thing B as target objects of monitoring by tapping the screen on which the thing A and the thing B are displayed. Thereafter, the user instructs a start of a monitoring mode on the use screen. Note that, when a target object is designated, a list of things to be candidates of the target object may be displayed on the use screen. In this case, the user may designate the thing A and the thing B as target objects of monitoring by selecting the thing A and the thing B out of the list.

As “Step 3” in using the baggage monitoring service, (c) of FIG. 2 illustrates a state of the inside of the store 2. The user moves away from the thing A and the thing B after instructing the start of the monitoring mode. For example, the user orders a commodity in the employee counter. For example, the user goes to a rest room. Although not illustrated, at this time, the employee can check a video of the camera 4a through a screen displayed on the store terminal 3. The user can check the video of the camera 4a through the personal terminal 5.

As “Step 4” in using the baggage monitoring service, (d) of FIG. 2 illustrates a state of the inside of the store 2 and the use screen of the personal terminal 5. In “Step 4”, for example, another person different from the user lifts the thing B of the user for the purpose of theft. In this case, the monitoring device 10 not illustrated in FIG. 2 detects, based on a video of the camera 4a, a change in the position of the thing B, which is a target object of monitoring. The monitoring device 10 causes the store terminal 3 and the personal terminal 5 to sound an alarm. The user checks the alarm for movement of the thing B and the video of the camera 4a on the use screen of the personal terminal 5. The employee of the store 2 checks the alarm for the movement of the thing B and the video of the camera 4a on the store use screen of the store terminal 3. For example, the employee takes an action corresponding to the alarm such as speaking to the other person.

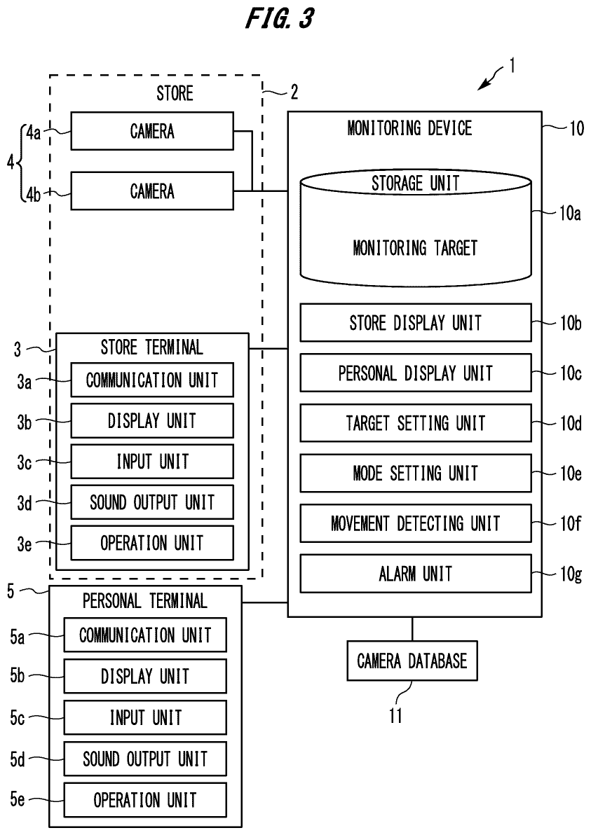

Subsequently, the monitoring system 1 is explained with reference to FIG. 3.

FIG. 3 is a block diagram of the monitoring system in the first embodiment.

FIG. 3 illustrates devices relating to the store 2 illustrated in FIG. 1 in the monitoring system 1. The monitoring system 1 includes the store terminal 3, the plurality of cameras 4, a camera database 11, the personal terminal 5, and the monitoring device 10. Note that, although not illustrated, when the monitoring system 1 is applied in another store different from the store 2, the monitoring system 1 includes the store terminal 3 and the camera 4 provided in the other store. Although not illustrated, when a plurality of users use the baggage monitoring service, the monitoring system 1 includes a plurality of personal terminals 5 carried by the plurality of users.

For example, a storage medium storing the camera database 11 is provided in the same building as a building in which the monitoring device 10 is provided. The camera database 11 stores information with which identification information of a camera included in the monitoring system 1 and information concerning a store where the camera is installed are associated.

The store terminal 3 includes a communication unit 3a, a display unit 3b, an input unit 3c, a sound output unit 3d, and an operation unit 3e.

The communication unit 3a performs communication with the monitoring device 10. The display unit 3b displays information to a person. For example, the display unit 3b is a liquid crystal display. The input unit 3c receives input of information from the person. For example, the input unit 3c is a mouse and a keyboard of a personal computer. The sound output unit 3d emits sound. For example, the sound output unit 3d is a speaker.

The operation unit 3e controls the store application. The operation unit 3e causes the display unit 3b to display a store use screen based on information received from the monitoring device 10. The operation unit 3e receives information input to the input unit 3c. The operation unit 3e transmits the input information to the monitoring device 10 via the communication unit 3a. The operation unit 3e causes the display unit 3b and the sound output unit 3d to sound an alarm based on information received from the monitoring device 10. Specifically, when receiving a command to emit an alarm, the operation unit 3e causes the display unit 3b to display that the alarm has been received. The operation unit 3e causes the sound output unit 3d to emit sound indicating the alarm.

The plurality of cameras 4 include a camera 4a and a camera 4b. Each of the plurality of cameras 4 transmits, to the monitoring device 10, information with which information concerning a photographed video and information for identifying the camera 4 are associated.

The personal terminal 5 includes a communication unit 5a, a display unit 5b, an input unit 5c, a sound output unit 5d, and an operation unit 5e.

The communication unit 5a performs communication with the monitoring device 10. The display unit 5b displays information to a person. For example, the display unit 5b is a touch panel-type liquid crystal display. The input unit 5c receives input of information from the person. For example, the input unit 5c is a tactile sensor of a touch panel. The sound output unit 5d emits sound. For example, the sound output unit 5d is a speaker.

The operation unit 5e controls a personal application for using the baggage monitoring service. The operation unit 5e causes the display unit 5b to display the use screen based on information received from the monitoring device 10. The operation unit 5e receives information input to the input unit 5c. The operation unit 5e transmits the input information to the monitoring device 10 via the communication unit 5a. The operation unit 5e causes the display unit 5b and the sound output unit 5d to sound an alarm based on the information received from the monitoring device 10. Specifically, when receiving a command to sound an alarm, the operation unit 5e causes the display unit 5b to display that the alarm has been received. The operation unit 5e causes the sound output unit 5d to emit sound indicating the alarm.

The monitoring device 10 specifies, based on information stored in the camera database 11, the store 2 where the camera 4 is installed. The monitoring device 10 includes a storage unit 10a, a store display unit 10b, a personal display unit 10c, a target setting unit 10d, a mode setting unit 10e, a movement detecting unit 10f, and an alarm unit 10g.

The storage unit 10a stores information concerning a monitoring target. The information concerning the monitoring target is information with which identification information of the store 2 where the monitoring target is set, identification information of the camera 4 that photographs a picture to be the monitoring target, identification information of the personal terminal 5 that has designated the monitoring target, and information concerning a region of the picture set as the monitoring target are associated. When the monitoring target is an image of a target object, not information concerning a region of the picture set as the monitoring target but information concerning the image of the target object is associated with the monitoring target information.

Note that position specifying information for specifying a position of the target object may be associated with the information concerning the monitoring target. For example, the position specifying information is coordinate information of the target object in a video of the camera 4. Note that the position specifying information may be information indicating exterior features of the image of the target object in the video of the camera 4.

The store display unit 10b creates information of a store use screen to be displayed on the store terminal 3. The store display unit 10b receives the information from the store terminal 3 via the store use screen.

Specifically, for example, the store display unit 10b creates information of the store use screen on which a video of the camera 4 is displayed. In the video, a monitoring target is marked by being surrounded by a frame line. Note that the store display unit 10b may create information of the store use screen including information concerning the user who uses the monitoring service. For example, the information concerning the user is ID information of the personal terminal 5 of the user. In this case, in the video, ID information corresponding to the monitoring target may be displayed together with the monitoring target.

The personal display unit 10c receives, from the personal terminal 5, via the use screen, identification information of a designated store 2, identification information of a designated camera 4, information for designating, as a monitoring target, a region of a picture of the camera 4 including a target object, information concerning a set target object, and a command to start monitoring. For example, the personal display unit 10c receives an instruction input to the personal terminal 5 via the use screen.

The personal display unit 10c creates, based on an instruction from the personal terminal 5, information of the use screen to be displayed on the personal terminal 5 to display the information on the personal terminal 5. Specifically, for example, when receiving, from the personal terminal 5, a command to display a monitoring target set by the personal terminal 5, the personal display unit 10c creates information of the use screen on which a video of the camera 4 reflecting the monitoring target is displayed. In the video, the monitoring target is marked by being surrounded by a frame line. When the monitoring target is being monitored, the personal display unit 10c creates information of the use screen on which it is displayed that the monitoring target is being monitored.

When receiving, from the personal terminal 5, via the use screen, a command to designate a region of a picture photographed by the camera 4 as a monitoring target, the target setting unit 10d sets the region of the picture as the monitoring target. When the monitoring target has been set, the target setting unit 10d creates information concerning the monitoring target and causes the storage unit 10a to store the information.

Note that the target setting unit 10d may set an image of a thing in the picture of the camera 4 as an image of a target object. In this case, the target setting unit 10d may detect an image of an object in a video of the camera 4. For example, the target setting unit 10d detects images such as an image of a notebook personal computer, an image of a bag, and an image of a desk in the video of the camera 4. When receiving, from the personal terminal 5, a command to designate a thing as a target object of monitoring, the target setting unit 10d specifies an image of the thing and sets an image of the target object, which is the image of the thing, as a monitoring target. When the monitoring target has been set, the target setting unit 10d creates information concerning the monitoring target corresponding to the target object and causes the storage unit 10a to store the information.

When receiving a command from the personal terminal 5 to start monitoring, the mode setting unit 10e starts monitoring concerning a monitoring target associated with the personal terminal 5. Specifically, the mode setting unit 10e sets a monitoring mode. When receiving, from the personal terminal 5, a command to release the monitoring, the mode setting unit 10e releases the monitoring mode concerning the monitoring target associated with the personal terminal 5.

When the position of a target object has moved, the movement detecting unit 10f analyzes a video of the camera 4 to detect that the position of the target object reflected in the camera 4 has moved. Specifically, the movement detecting unit 10f differentially analyzes only a change that has occurred in a region of a picture, which is a monitoring target. That is, the movement detecting unit 10f compares an image of a region of a picture set as the monitoring target and an image of a corresponding region in a picture received from the camera 4 and analyzes only whether a difference has occurred in the pictures. When detecting that the image of the region of the picture has changed, the movement detecting unit 10f detects that the position of the target object has moved. For example, the position of the target object moves when disturbance such as a motion of a person or wind or the like acts on the target object. When detecting that the position of the target object has moved, the movement detecting unit 10f detects an abnormality.

Note that, when an image of a target object is set as a monitoring target, the movement detecting unit 10f detects, with a picture differential analysis, that the image of the target object in a picture of the camera 4 has changed. At this time, the movement detecting unit 10f performs the same operation as an operation performed when a region of a picture is set as a monitoring target.

When an abnormality has been detected by the movement detecting unit 10f, the alarm unit 10g transmits a command to emit an alarm to the effect that the abnormality has occurred to the store terminal 3 of the store 2 and the personal terminal 5 associated with the monitoring target.

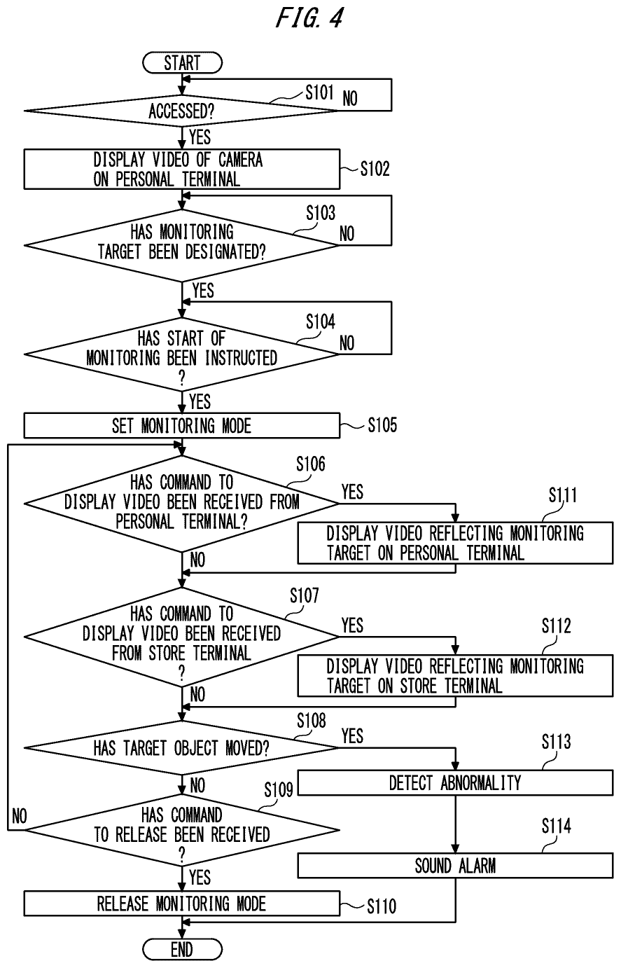

Subsequently, an operation performed in the baggage monitoring service is explained with reference to FIG. 4.

FIG. 4 is a flowchart for explaining an overview of an operation of the monitoring system in the first embodiment.

FIG. 4 illustrates an operation of the baggage monitoring service performed by the monitoring system 1.

In step S101, the personal display unit 10c of the monitoring device 10 determines whether the baggage monitoring service has been accessed from the personal terminal 5.

When the baggage monitoring service has not been accessed from the personal terminal 5 in step S101, the personal display unit 10c repeats the operation in step S101.

When it is determined in step S101 that the baggage monitoring service has been accessed, the operation in step S102 is performed. In step S102, the personal display unit 10c creates information of the use screen to be displayed by the personal terminal 5. The personal display unit 10c receives input of identification information of the store 2 from the personal terminal 5. The personal display unit 10c receives selection of one of the cameras 4a and 4b from the personal terminal 5. The personal display unit 10c displays, on the use screen, a video photographed by the selected camera 4 of the cameras 4a and 4b. Note that, when receiving the camera selection, the personal display unit 10c may display videos photographed by the cameras 4a and 4b respectively on the use screen.

Thereafter, an operation in step S103 is performed. In step S103, the personal display unit 10c determines whether a monitoring target has been designated in the personal terminal 5.

When a monitoring target has not been designated in step S103, the personal display unit 10c repeats the operation in step S103.

When a monitoring target has been designated in step 103, an operation in step S104 is performed. In step S104, the target setting unit 10d creates information concerning the monitoring target, which is an image of a region of a designated picture or an image of a target object. The personal display unit 10c determines whether a start of monitoring has been instructed in the personal terminal 5.

When the start of monitoring has not been instructed in step S104, the operation in step S104 is repeated.

When the start of the monitoring has been instructed in step S104, an operation in step S105 is performed. In step S105, the mode setting unit 10e sets a monitoring mode.

Thereafter, an operation in step 106 is performed. In step S106, the personal display unit 10c determines whether a command to display a video of the monitoring target has been received from the personal terminal 5.

When it is determined in step S106 that a command to display a video of the monitoring target has not been received from the personal terminal 5, an operation in step S107 is performed. In step S107, the store display unit 10b determines whether a command for displaying a video of the monitoring target has been received from the store terminal 3.

When it is determined in step S107 that a command to display a video of the monitoring target has not been received from the store terminal 3, an operation in step S108 is performed. In step S108, the movement detecting unit 10f determines whether the target object has moved.

When movement of the target object has not been detected in step S108, an operation in step 109 is performed. In step S109, the mode setting unit 10e determines whether a command to release the monitoring has been received from the personal terminal 5.

When it is determined in step S109 that a command to release the monitoring has not been received, the operations in step S106 and subsequent steps are performed.

When it is determined in step S109 that a command to release the monitoring has been received, an operation in step S110 is performed. In step S110, the mode setting unit 10e releases the monitoring mode.

Thereafter, the monitoring system 1 ends the operation.

When it is determined in step S106 that a command to display a video of the monitoring target has been received from the personal terminal 5, an operation in step S111 is performed. In step S111, the personal display unit 10c displays, on the personal terminal 5, a video reflecting the monitoring target. Thereafter, the operations in step S107 and subsequent steps are performed.

When it is determined in step S107 that a command to display a video of the monitoring target has been received from the store terminal 3, an operation in step S112 is performed. In step S112, the store display unit 10b displays, on the store terminal 3, a video reflecting the monitoring target. Thereafter, the operations in step S108 and subsequent steps are performed.

When the movement detecting unit 10f has detected movement of the target object in step S108, an operation in step S113 is performed. In step S113, the movement detecting unit 10f detects an abnormality. The alarm unit 10g transmits, to the store terminal 3 and the personal terminal 5, a command to emit an alarm to the effect that the abnormality has occurred in the target object.

Thereafter, an operation in step S114 is performed. In step S114, the store terminal 3 sounds an alarm. The personal terminal 5 sounds an alarm. Thereafter, the monitoring system 1 ends the operation.

According to the first embodiment explained above, the monitoring device 10 includes the mode setting unit 10e, the target setting unit 10d, and the movement detecting unit 10f. The monitoring device 10 sets, as a monitoring target, an image of a region of a picture designated from the personal terminal 5 or an image of a target object. When a thing set as a target object of monitoring has moved, the monitoring device 10 detects an abnormality. Even if the user is present in a place apart from baggage or an own seat, the user can set the baggage as a target object of monitoring by operating the personal terminal 5. That is, even if the user has forgot to set the baggage as a target object of monitoring and has left the own seat, the user can set the baggage as a target object of monitoring. Therefore, it is possible to improve convenience of a service for monitoring the baggage.

When an image of a target object, which is a monitoring target, or an image of a region of a picture has changed in a picture of the camera 4, the monitoring device 10 detects that the target object has moved. Therefore, it is possible to detect movement of the target object based on information concerning the picture of the camera 4. When a change is detected by a differential analysis of the image, it is possible to detect movement of the target object with a small calculation amount.

The monitoring device 10 includes the alarm unit 10g. When an abnormality has been detected for the target object, the monitoring device 10 causes the store terminal 3 and the personal terminal 5 to sound an alarm. For example, the user can receive the alarm in the personal terminal 5. Therefore, when the abnormality has been detected, the employee of the store 2 and the user can learn that the abnormality has occurred in the target object. For example, the employee or the user can take an action of, for example, moving to a place of the target object in which the abnormality has occurred. As a result, crime preventability is improved. Here, a case in which the order terminal described in PTL 1 is installed is conceived. When detecting that baggage has moved, the order terminal displays an alarm and sounds voice of an alarm. In this case, when a user of the store is present in a position away from an own seat, the user cannot learn that the alarm has been output. With the monitoring device 10 in this embodiment, since the monitoring device 10 causes the personal terminal 5 of the user to sound an alarm, it is possible to improve crime preventability. As a result, the user can freely leave the seat without concerning about luggage lifting and the like while leaving the baggage in the own seat.

The monitoring device 10 includes the personal display unit 10c. The monitoring device 10 receives, on the use screen of the personal terminal 5 on which a video photographed by the camera 4 is displayed, designation of a thing to be set as a target object or designation of a region of an image to be a monitoring target. Therefore, the user can more accurately designate a thing that the user desires to designate as a target object.

The monitoring device 10 causes, based on a command from the personal terminal 5, the personal terminal 5 to display a video of the camera 4 that photographs the monitoring target. Therefore, the user can watch and check a state of the target object of monitoring from a place apart from the own seat. As a result, it is possible to give a sense of security to the user.

The monitoring device 10 includes the store display unit 10b. The monitoring device 10 causes, based on a command from the store terminal 3, the store terminal 3 to display a video of the camera 4 that photographs the monitoring target. Therefore, the employee of the store can check a state of the target object. As a result, crime preventability is improved.

The monitoring system 1 includes the posting body 6. The posting body 6 makes it well known that the monitoring service is performed in the store 2. Therefore, it is possible to make it well known to people planning crimes such as luggage lifting that a risk of executing crimes in the store 2 is high. As a result, it is possible to suppress crimes.

Note that the store terminal 3 and the camera database 11 may not be included in the monitoring system 1.

Note that the baggage monitoring service may be provided not through a dedicated application but through a web browser. In this case, the store terminal 3 may display the store use screen through the web browser. The operation unit 3e of the store terminal 3 may perform transmission and reception of information to and from the monitoring device 10 through software for controlling the web browser. The personal terminal 5 may display the use screen through the web browser. The operation unit 5e of the personal terminal 5 may perform transmission and reception of information to and from the monitoring device 10 through the software for controlling the web browser.

Note that the monitoring device 10 may be provided in the same building as the store 2. The monitoring device 10 may be incorporated in the store terminal 3.

Note that the camera database 11 may be a database present on a cloud server. The camera database 11 may be provided in a building different from the building in which the monitoring device 10 is provided. In this case, the camera database 11 may be dividedly stored in a plurality of storage media provided in different places.

Note that the posting body 6 may not be included in the monitoring system 1 and may not be provided in the store 2.

Note that, in addition to the posting body 6, a posting image indicating that the monitoring system 1 is introduced in the store 2 may be displayed in a web site for public relation of the store 2.

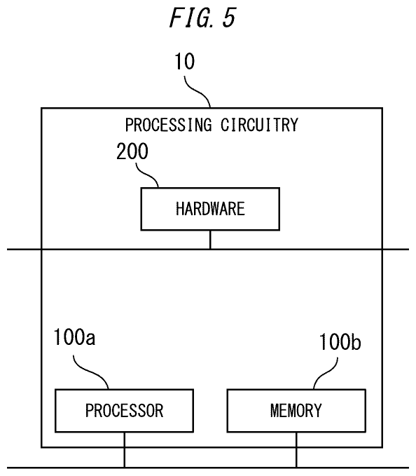

Subsequently, an example of hardware configuring the monitoring device 10 is explained with reference to FIG. 5.

FIG. 5 is a hardware configuration diagram of the monitoring device of the monitoring system in the first embodiment.

The functions of the monitoring device 10 can be implemented by processing circuitry. For example, the processing circuitry includes at least one processor 100a and at least one memory 100b. For example, the processing circuitry includes at least one dedicated hardware 200.

When the processing circuitry includes the at least one processor 100a and the at least one memory 100b, the functions of the monitoring device 10 are implemented by software, firmware, or a combination of the software and the firmware. At least one of the software and the firmware is described as a program. At least one of the software and the firmware is stored in at least one memory 100b. The at least one processor 100a implements the functions of the monitoring device 10 by reading and executing the program stored in the at least one memory 100b. The at least one processor 100a is also referred to as central processing unit, processing device, arithmetic device, microprocessor, microcomputer, or DSP. For example, the at least one memory 100b is a nonvolatile or volatile semiconductor memory such as a RAM, a ROM, a flash memory, an EPROM, or an EEPROM, a magnetic disk, a flexible disk, an optical disk, a compact disk, a minidisk, a DVD, or the like.

When the processing circuitry includes the at least one dedicated hardware 200, the processing circuitry is implemented by, for example, a single circuit, a composite circuit, a programmed processor, a parallel-programmed processor, an ASIC, an FPGA, or a combination of the foregoing. For example, the functions of the monitoring device 10 are respectively implemented by processing circuitry. For example, the functions of the monitoring device 10 are collectively implemented by processing circuitry.

A part of the functions of the monitoring device 10 may be implemented by the dedicated hardware 200 and the other part may be implemented by software or firmware. For example, the function of analyzing a difference of a picture may be implemented by processing circuitry functioning as the dedicated hardware 200. The functions other than the function of analyzing a difference of a picture may be implemented by the at least one processor 100a reading and executing the program stored in the at least one memory 100b.

As explained above, the processing circuitry implements the functions of the monitoring device 10 with the dedicated hardware 200, software, firmware, or a combination of the foregoing.

Although not illustrated, the functions of the store terminal 3 are also implemented by processing circuitry equivalent to the processing circuitry that implements the functions of the monitoring device 10. Although not illustrated, the functions of the personal terminal 5 are also implemented by processing circuitry equivalent to the processing circuitry that implements the functions of the monitoring device 10.

The program included in the monitoring system 1 may cause the monitoring device 10 to execute steps equivalent to the functions of the monitoring device 10. For example, the program may cause the monitoring device 10 to execute a mode setting step, a thing detecting step, and a movement detecting step. In the mode setting step, the monitoring device 10 sets, based on a command from the personal terminal 5 to start monitoring, a monitoring mode for watching a thing. In the thing detecting step, the monitoring device 10 sets, as a monitoring target, a region of a picture designated from the personal terminal 5 of the user or an image of a target object. In the movement detecting step, when the monitoring mode is set, the monitoring device 10 detects an abnormality when detecting that the target object reflected in a video photographed by the camera 4 has moved.

The monitoring device 10 provides the baggage monitoring service using a monitoring method. The monitoring method includes steps corresponding to the functions of the monitoring device 10. For example, the monitoring method includes a mode setting step, a thing detecting step, and a movement detecting step.

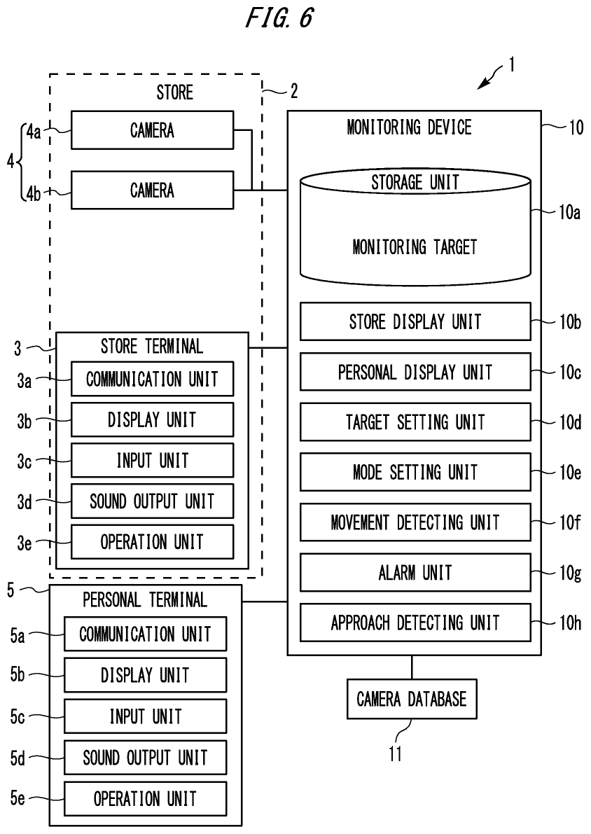

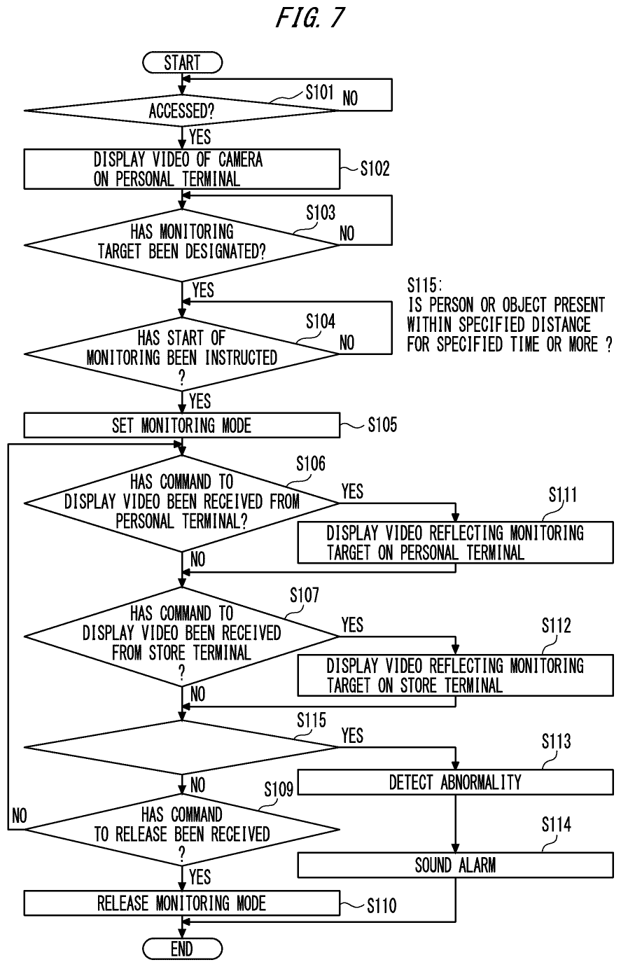

Subsequently, a first modification of the monitoring system 1 in the first embodiment is explained with reference to FIG. 6 and FIG. 7.

FIG. 6 is a block diagram of the first modification of the monitoring system in the first embodiment. FIG. 7 is a flowchart for explaining an overview of an operation of the first modification of the monitoring system in the first embodiment.

As illustrated in FIG. 6, in the first modification of the first embodiment, the monitoring device 10 further includes an approach detecting unit 10h.

The approach detecting unit 10h detects positions of a person and an object reflected in a video of the camera 4. The approach detecting unit 10h detects, based on the video of the camera 4, that the person or the object is present within a specified distance from a target object. When the person or the object is present within the specified distance for a specified time or more from a target object, the approach detecting unit 10h detects an abnormality. Note that, when a region of a picture is set as a monitoring target, the approach detecting unit 10h may regard a distance on the picture between the center of the region of the picture and the person or the object as a distance between the person or the object and the target object.

When the approach detecting unit 10h has detected the abnormality, the alarm unit 10g transmits, to the store terminal 3 of the store 2 and the personal terminal 5 associated with the monitoring target, a command to emit an alarm to the effect that the abnormality has occurred.

As illustrated in FIG. 7, in the first modification, step S101 to step S107, step S111, and step S112 of the flowchart are the same as the steps of the flowchart of FIG. 4. That is, when it is determined in step S106 that the command to display a video of the monitoring target has been received from the personal terminal 5, the operation in step S111 is performed. After the operation in step S111 is performed, the operation in step S107 is performed. When it is determined in step S107 that the command to display a video of the monitoring target has been received from the store terminal 3, the operation in step S112 is performed.

When it is determined in step S107 that the command to display a video of the monitoring target has not been received from the store terminal 3 or when the operation in step S112 has been performed, an operation in step S115 is performed. In step S115, the approach detecting unit 10h of the monitoring device 10 determines whether a person or an object is present within the specified distance from the target object for the specified time or more.

When it is determined in step S115 that a time in which the person or the object is present within the specified distance from a target object does not exceed the specified time, the operation in step S109 is performed. Step S109 and step S110 are the same as the steps of the flowchart of FIG. 4.

When it is determined in step S115 that the person or the object is present within the specified distance from a target object for the specified time or more, operations in step S113 and subsequent steps are performed. Step S113 and step S114 are the same as the steps of the flowchart of FIG. 4.

According to the first modification of the first embodiment explained above, the monitoring device 10 includes the approach detecting unit 10h. Therefore, the monitoring device 10 can detect an abnormality before a target object of monitoring moves and sound an alarm. As a result, it is possible to prevent crimes such as luggage lifting.

Note that, in the first modification, the monitoring device 10 may detect an abnormality when detecting that the position of the target object has moved. In this case, for example, the operation in step S108 may be performed when an abnormality has not been detected in step S115 in FIG. 7.

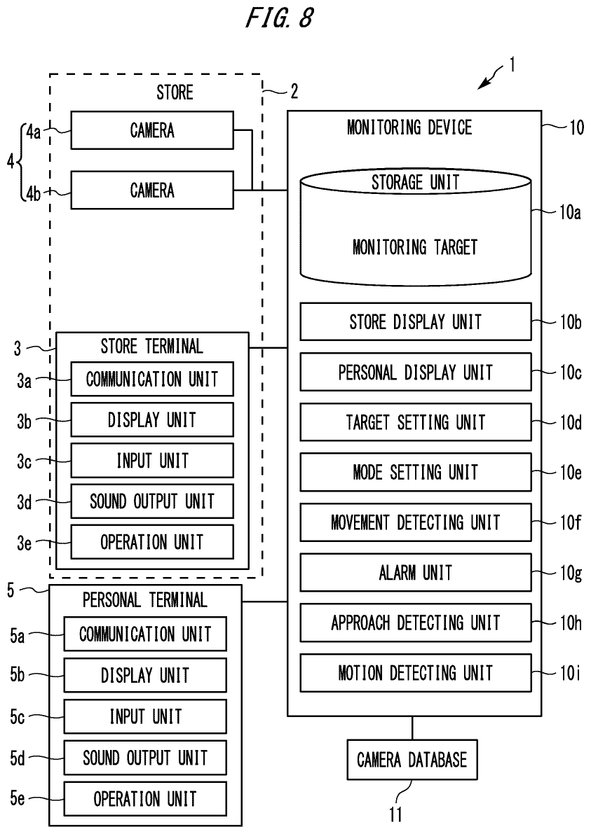

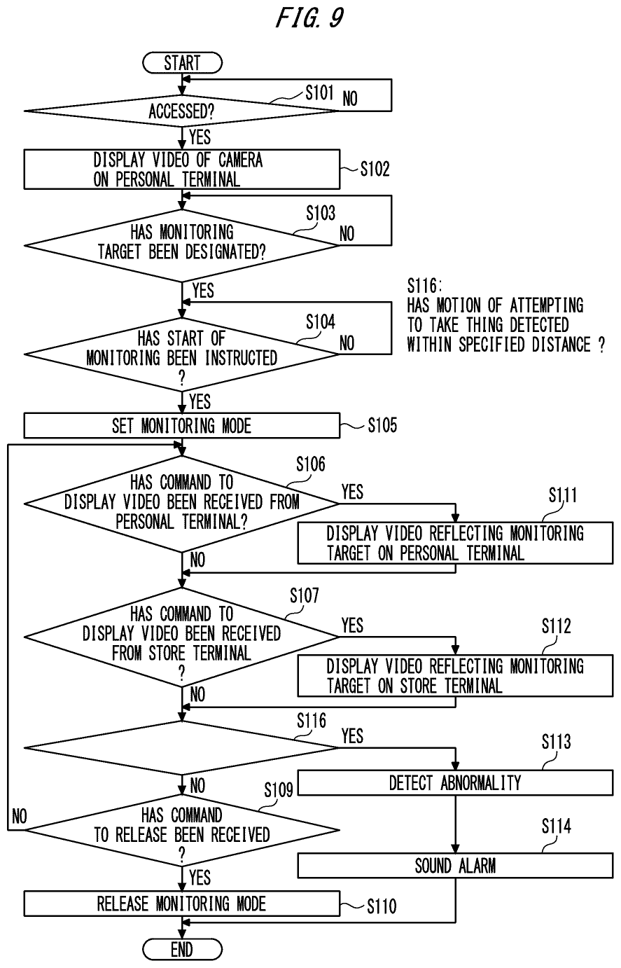

Subsequently, a second modification of the monitoring system 1 in the first embodiment is explained with reference to FIG. 8 and FIG. 9.

FIG. 8 is a block diagram of the second modification of the monitoring system in the first embodiment. FIG. 9 is a flowchart for explaining an overview of an operation of the second modification of the monitoring system in the first embodiment.

As illustrated in FIG. 8, in the second modification of the first embodiment, the monitoring device 10 further includes a motion detecting unit 10i.

The motion detecting unit 10i detects a movement of a person reflected in a video of the camera 4 to detect a motion of the person attempting to take a thing. Specifically, the motion detecting unit 10i analyzes a movement of the skeleton of the person based on the video of the camera 4. For example, the motion detecting unit 10i analyzes the movement of the skeleton of the person to respectively specify human sites such as the tips of the hands and the joints of the arms and the shoulders. At this time, the motion detecting unit 10i may use a skeleton analysis program such as “Kotsumon”. The motion detecting unit 10i detects, based on specified movements of the hands and the arms of the person, that the person is performing a motion of attempting take a thing. Note that, for example, the motion of the person attempting to take a thing is a motion such as a motion of the person stretching a hand to a thing or a motion of the person attempting to stretch a hand to a thing.

In a state in which the person is present within the specified distance from the target object, when the motion detecting unit 10i has detected the motion of the person attempting to take a thing, the approach detecting unit 10h detects an abnormality.

As illustrated in FIG. 9, in the second modification, step S101 to step S107, step S111, and step S112 of the flowchart are the same as the steps of the flowchart of FIG. 4.

When it is determined in step S107 that the command to display a video of the monitoring target has not been received from the store terminal 3 or when the operation in step S112 is performed, the operation in step S116 has been performed. In step S116, the approach detecting unit 10h of the monitoring device 10 determines whether, in a state in which a person is present within the specified distance from the target object, the motion detecting unit 10i has detected a motion of the person attempting to take a thing.

When a person is absent within the specified distance from the target object in step S116 or when, in a state in which a person is present within the specified distance from the target object, a motion of the person attempting to take a thing has not been detected in step S116, the operation in step S109 is performed. Step S109 and step S110 are the same as the steps of the flowchart of FIG. 4.

When, in a state in which a person is present within the specified distance from the target object, a motion of the person attempting to take a thing has been detected in step S116, the operation in step S113 is performed. Step S113 and step S114 are the same as the steps of the flowchart of FIG. 4.

According to the second modification of the first embodiment explained above, the monitoring device 10 includes the approach detecting unit 10h and the motion detecting unit 10i. When detecting a motion of a person present within the specified distance from the target object attempting to take a thing, the monitoring device 10 detects an abnormality. Therefore, it is possible to detect only a person who has approached the target object with an intention of taking a thing. As a result, it is possible to prevent an alarm from being erroneously sounded for a movement of a person not having an intention of theft or the like.

The monitoring device 10 analyzes a movement of the skeleton of a person reflected on a video of the camera 4 to detect a motion of the person attempting to take the target object. Therefore, it is possible to more accurately detect a movement of the person.

Note that the monitoring device 10 may concurrently perform the operation in the first embodiment and the operation in the first modification of the first embodiment. Specifically, when not detecting an abnormality in S116 in the flowchart of FIG. 9, the monitoring device 10 may perform the operation in step S108 in the flowchart of FIG. 4 and the operation in step S115 in the flowchart of FIG. 7.

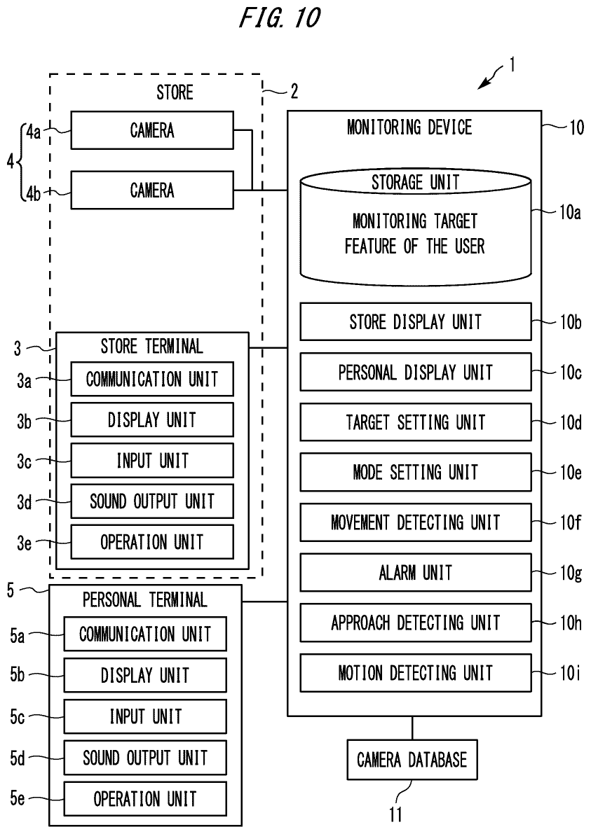

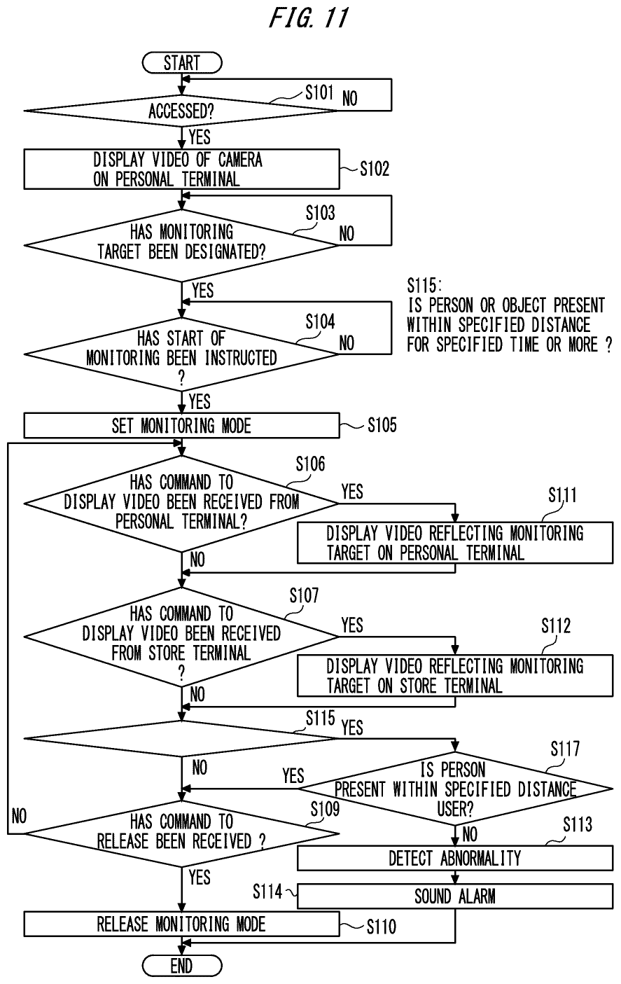

Subsequently, a third modification of the monitoring system 1 in the first embodiment is explained with reference to FIG. 10 and FIG. 11.

FIG. 10 is a block diagram of the third modification of the monitoring system in the first embodiment. FIG. 11 is a flowchart for explaining an overview of an operation of the third modification of the monitoring system in the first embodiment.

As illustrated in FIG. 10, the storage unit 10a stores feature information of the user. The feature information is information indicating exterior features such as height, clothes, and a face of the user. The feature information is stored in the storage unit 10a in advance. Note that the personal display unit 10c may create the feature information based on content input to the use screen by the user. The personal display unit 10c may create the feature information based on an image reflecting a registered user.

The approach detecting unit 10h analyzes a video of the camera 4 based on the feature information stored in the storage unit 10a to determine whether a person within the specified distance from the target object is the user who designated the monitoring target. When determining that the person is the user, the approach detecting unit 10h does not detect an abnormality even if the approach detecting unit 10h detects that the person is present within the specified distance from the target object.

As illustrated in FIG. 11, in the third modification, step S101 to step S107 and S115 of the flowchart are the same as the steps of the flowchart of FIG. 7.

When it is determined in step S115 that a person or an object is present within the specified distance from the target object for the specified time or more, an operation in step S117 is performed. In step S117, the approach detecting unit 10h of the monitoring device 10 determines whether a person is present within the specified distance from the target object and the person is a user who designated the target object.

When it is determined in step S117 that the person present within the specified distance from the target object is the user who designated the target object, the operation in step S109 is performed. Step S109 and step S110 are the same as the steps of the flowchart of FIG. 7.

When an object is present within the specified distance from the target object in step S117 or when it is determined in step S117 that the person present within the specified distance from the target object is not the user who designated the target object, the operation in step S113 is performed. Step S113 and step S114 are the same as the steps of the flowchart of FIG. 7.

According to the third modification of the first embodiment explained above, when a person present within the specified distance from the target object is a user corresponding to the target object, the monitoring device 10 does not detect an abnormality even if the specified time has elapsed. Therefore, for example, it is possible to prevent an abnormality from being detected when a person who designated a thing of the person as a monitoring target returns to the own seat.

Note that the third modification may be applied to the second modification. Specifically, in the second modification, even if the approach detecting unit 10h has detected a person who performed a motion of attempting to take a thing, when determining that the person is a user, the approach detecting unit 10h may not detect occurrence of an abnormality. Therefore, for example, it is possible to prevent an abnormality from being detected when a person who designated a target object of monitoring has performed a motion of taking the target object in hand. In the third modification, as in the second modification, the movement detecting unit 10f may detect that the target object has moved.

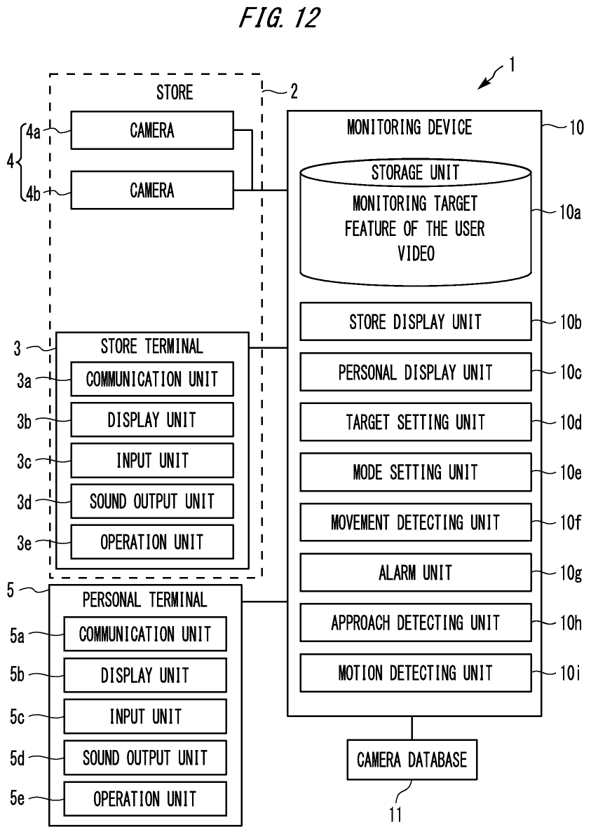

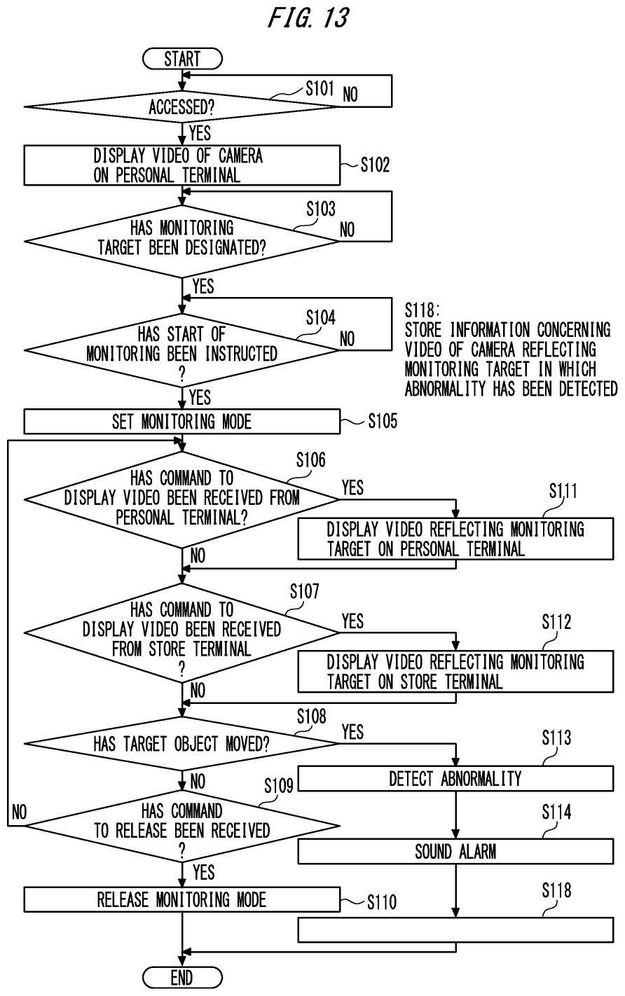

Subsequently, a fourth modification of the monitoring system 1 in the first embodiment is explained with reference to FIG. 12 and FIG. 13.

FIG. 12 is a block diagram of the fourth modification of the monitoring system in the first embodiment. FIG. 13 is a flowchart for explaining an overview of an operation of the fourth modification of the monitoring system in the first embodiment.

As illustrated in FIG. 12, in the fourth embodiment, the storage unit 10a stores information concerning a video at an alarm time.

When transmitting a command to emit an alarm to the effect that an abnormality has occurred in the store terminal 3 and the personal terminal 5, the alarm unit 10g causes the storage unit 10a to store information concerning a video of the camera 4 reflecting a monitoring target in which the abnormality has been detected. Note that the alarm unit 10g may cause the storage unit 10a to store information concerning a picture of the camera 4 reflecting the monitoring target in which the abnormality has been detected.

As illustrated in FIG. 13, in the fourth modification, step S101 to step S114 of the flowchart are the same as the steps of the flowchart of FIG. 4.

After step S114, an operation in step S118 is performed. In step S118, the alarm unit 10g of the monitoring device 10 causes the storage unit 10a to store information concerning a video of the camera 4 reflecting a monitoring target in which the abnormality has been detected. Thereafter, the monitoring system 1 ends the operation.

According to the fourth modification of the first embodiment explained above, when sounding an alarm, the monitoring device 10 stores information concerning a video or a picture of the camera 4 reflecting the monitoring target. Therefore, it is possible to keep a record of the target object being stolen by a person. As a result, it is possible to contribute to proof of crimes such as theft.

Note that the monitoring device 10 may concurrently perform the operations in the first modification, the second modification, the third modification of the first embodiment. Specifically, when not detecting an abnormality in S108 in the flowchart of FIG. 13, the monitoring device 10 may respectively perform the operation in step S115 in the flowchart of FIG. 7, the operation in step S116 in the flowchart of FIG. 9, and the operations in step S115 to step S117 in the flowchart of FIG. 9.

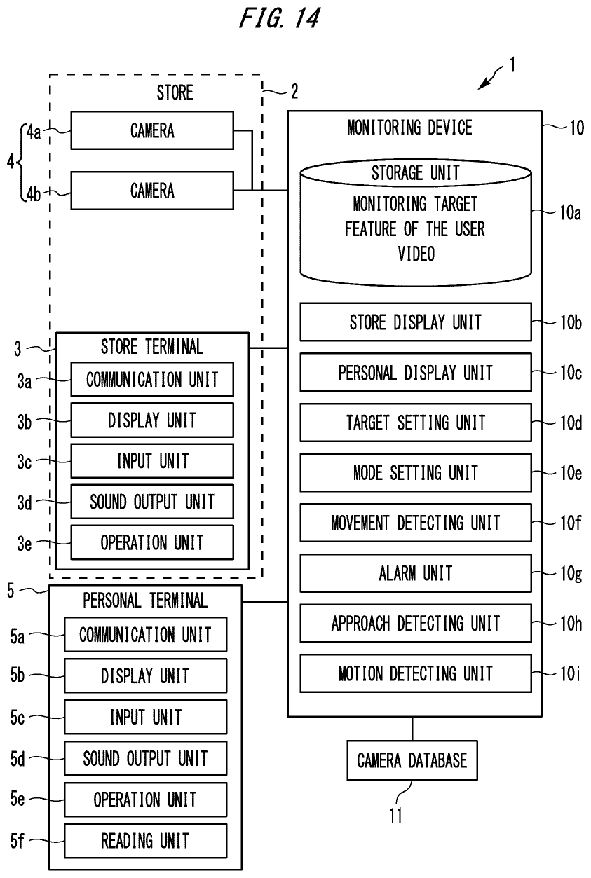

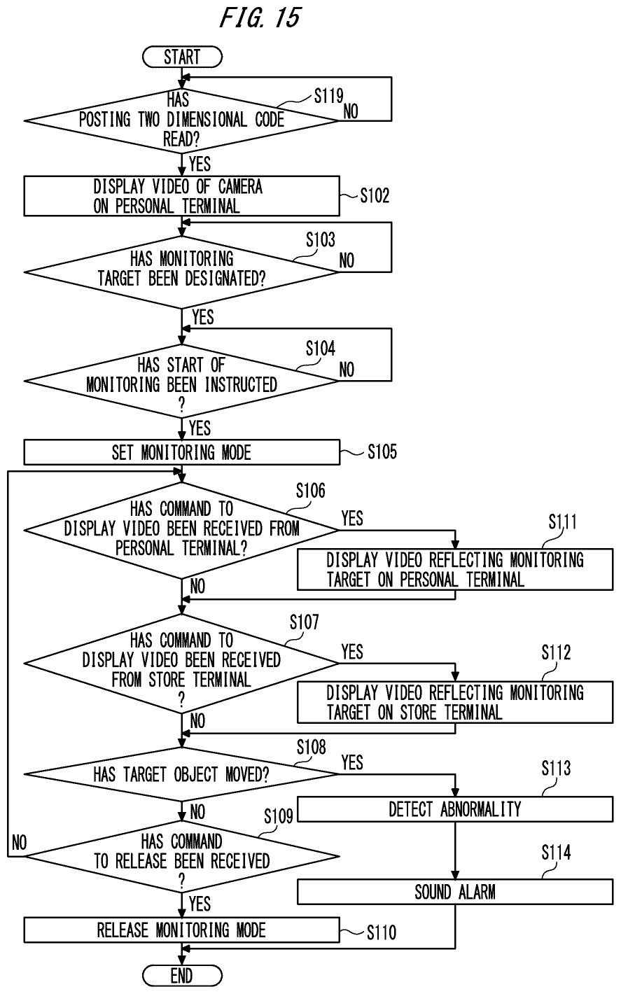

Subsequently, a fifth modification of the monitoring system 1 in the first embodiment is explained with reference to FIG. 14 and FIG. 15.

FIG. 14 is a block diagram of a fifth modification of the monitoring system in the first embodiment. FIG. 15 is a flowchart for explaining an overview of an operation of the fifth modification of the monitoring system in the first embodiment.

Although not illustrated in FIG. 14, the posting two-dimensional code 6a is displayed on the posting body 6. For example, the posting two-dimensional code 6a is a QR code (registered trademark). The posting two-dimensional code 6a indicates access information for accessing the monitoring device 10 from the personal terminal 5. Specifically, for example, the access information is a URL of the use screen. For example, the access information is a URL for automatically starting the personal application for using the baggage monitoring service.

Note that the same two-dimensional code as the posting two-dimensional code 6a may be shown in a part of a posting picture posted in a web site for public relation of the store 2. A URL or the like may be shown in the posting picture as access information.

As illustrated in FIG. 14, in the fifth modification, the personal terminal 5 includes a reading unit 5f.

For example, the reading unit 5f includes a camera. The reading unit 5f can photograph an image reflecting a two-dimensional code such as a QR code (registered trademark). When photographing the posting two-dimensional code 6a, the reading unit 5f extracts the access information from the posting two-dimensional code 6a of a photographed picture.

When the reading unit 5f has extracted the access information, the personal terminal 5 accesses the use screen.

As illustrated in the flowchart of FIG. 15, in step S119, the reading unit 5f of the personal terminal 5 determines whether the reading unit 5f has read the posting two-dimensional code 6a.

When the reading unit 5f has not read the posting two-dimensional code 6a in step S119, the personal terminal 5 repeats the operation in step S119.

When the reading unit 5f has read the posting two-dimensional code 6a in step S119, the operations in step S102 and subsequent steps are performed. Step S102 and subsequent steps of the flowchart are the same as step S102 and subsequent steps of the flowchart of FIG. 4.

According to the fifth modification of the first embodiment explained above, the posting body 6 of the monitoring system 1 includes the posting two-dimensional code 6a. Therefore, the user can access the baggage monitoring service by reading the posting two-dimensional code 6a with the personal terminal 5. As a result, it is possible to improve convenience of the user. It is possible to further improve user experience (UX) of the baggage monitoring service.

### Second Embodiment

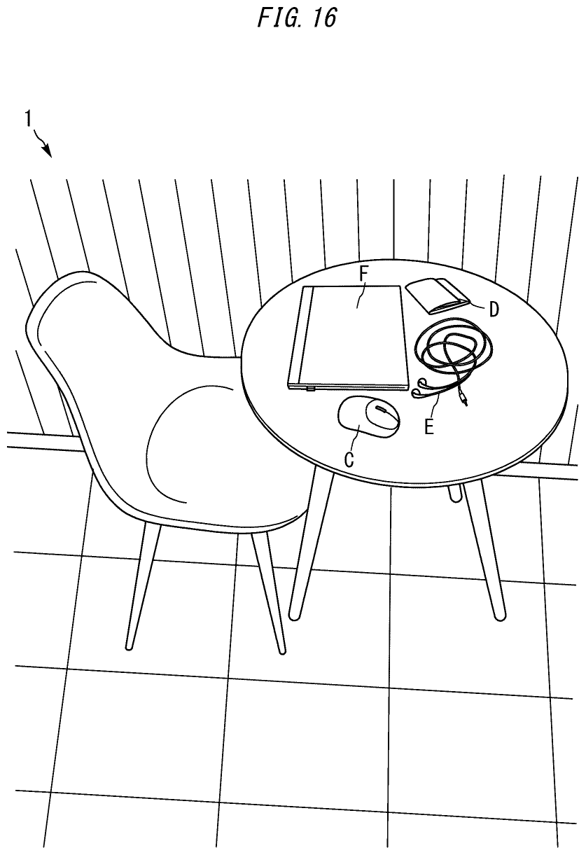

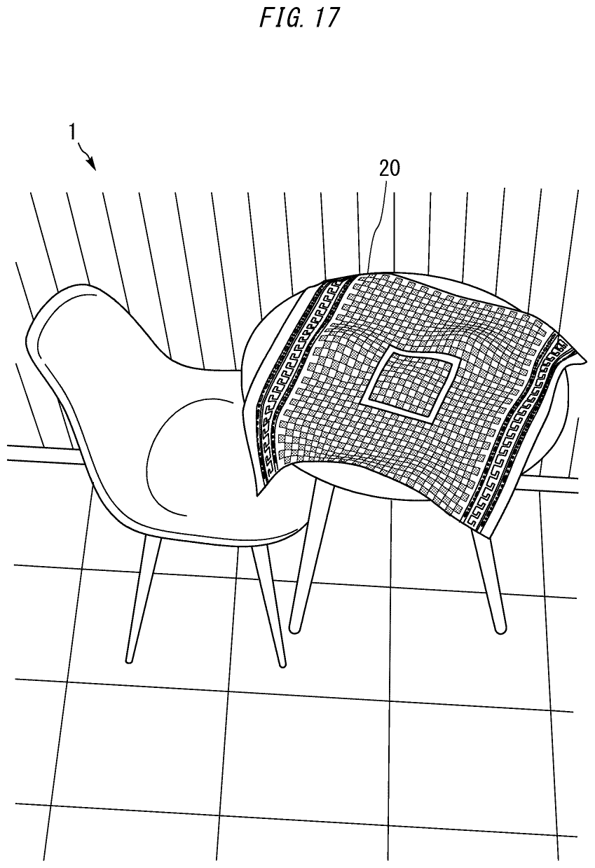

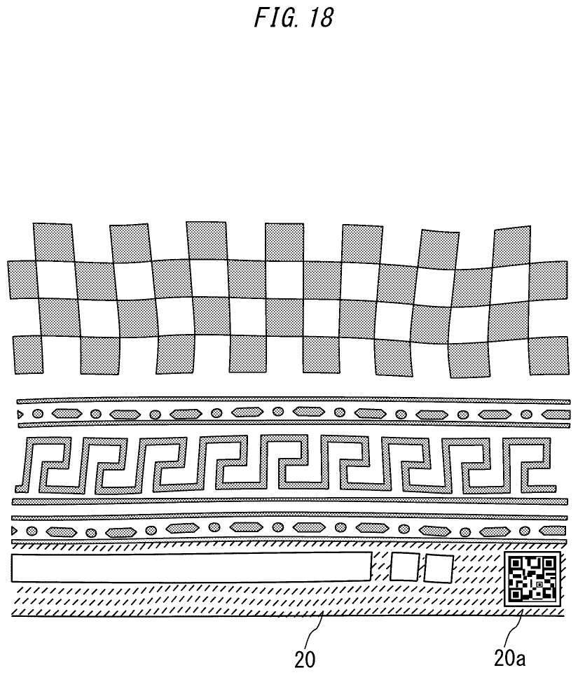

FIG. 16 is a diagram illustrating a target object before being applied with a monitoring system in a second embodiment. FIG. 17 is a diagram illustrating a covering body of the monitoring system in the second embodiment. FIG. 18 is a diagram illustrating a main part of the covering body of the monitoring system in the second embodiment. Note that portions that are the same as or equivalent to the portions in the first embodiment are denoted by the same reference numerals and signs. Explanation of the portions is omitted.

In FIG. 16, a plurality of things C, D, E, and F are placed on a desk. In the monitoring system 1 in the first embodiment, the monitoring device 10 not illustrated in FIG. 16 detects the plurality of things C, D, E, and F and watches the plurality of things C, D, E, and F respectively as target objects of monitoring.

FIG. 17 illustrates a covering body 20 in the second embodiment. For example, the covering body 20 is cloth having a specific pattern. Note that a form of the covering body 20 is not limited to a cloth form if the covering body 20 has a characteristic of covering a thing. For example, a plurality of covering bodies 20 are prepared in the store 2. In FIG. 17, a user of the baggage monitoring service covers the plurality of things C, D, E, and F illustrated in FIG. 16 with the covering body 20. The user sets the covering body 20 as a target object using the personal terminal 5.

The monitoring device 10 not illustrated in FIG. 17 sets the covering body 20 as a target object and watches the covering body 20. Specifically, the monitoring device 10 sets an image of the covering body 20 as a monitoring target. Note that the monitoring device 10 may set a region of a picture including the image of the covering body 20 as a monitoring target.

FIG. 18 illustrates a part of the covering body 20. The covering body 20 has an identifiable specific pattern, which is a specific characteristic pattern. For example, the specific characteristic pattern is a pattern including a combination of at least one of regular patterns, irregular patterns, and colors. The covering body 20 includes a covering body two-dimensional code 20a. The covering body two-dimensional code 20a is provided in a part of the covering body 20. For example, the covering body two-dimensional code 20a is a QR code (registered trademark). The covering body two-dimensional code 20a indicates covering body access information. For example, the covering body access information is information with which a URL for accessing the monitoring device 10 and identification information of the covering body 20 are associated.

For example, the user photographs the covering body two-dimensional code 20a with the personal terminal 5 not illustrated in FIG. 18. The personal terminal 5 extracts the covering body access information and accesses the monitoring device 10 not illustrated in FIG. 18. In this case, although not illustrated, the monitoring device 10 specifies the camera 4 that photographs the covering body 20 corresponding to the covering body access information. A video of the camera 4 that photographs the corresponding covering body 20 is displayed on the personal terminal 5.

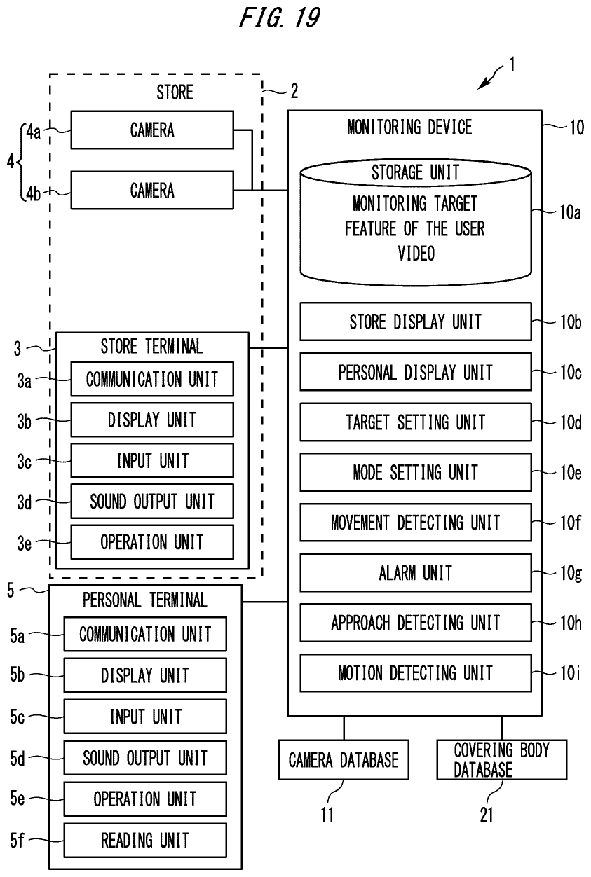

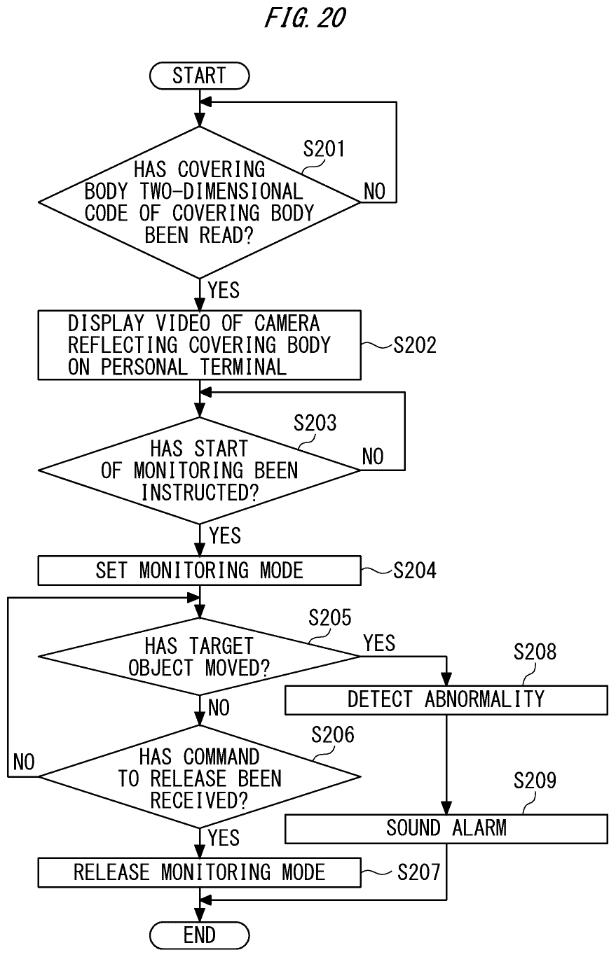

Subsequently, the monitoring system 1 is explained with reference to FIG. 19 and FIG. 20.

FIG. 19 is a block diagram of the monitoring system in the second embodiment. FIG. 20 is a flowchart for explaining an overview of an operation of the monitoring system in the second embodiment.

As illustrated in FIG. 19, the monitoring system 1 further includes a covering body database 21. Note that the covering body 20 is not illustrated in FIG. 19.

For example, a storage medium storing the covering body database 21 is provided in the same building as a building in which the monitoring device 10 is provided. The covering body database 21 stores covering body information with which identification information of the covering body 20 registered in the monitoring system 1, identification information of the store 2 where the covering body 20 is prepared, and information concerning a pattern of the covering body 20 are associated.

In the personal terminal 5, the reading unit 5f extracts the covering body access information from a picture in which the covering body two-dimensional code 20a is photographed. The operation unit 5e of the personal terminal 5 transmits the covering body access information to the monitoring device 10. The operation unit 5e accesses a use screen created by the monitoring device 10.

When the monitoring device 10 has received the covering body access information, the personal display unit 10c displays, based on the covering body access information, a video of the camera 4 reflecting the covering body 20 on the use screen corresponding to the personal terminal 5.

When the monitoring device 10 has received the covering body access information, the target setting unit 10d analyzes, based on the covering body information of the covering body database 21, an image of the covering body 20 reflected on the camera 4 to specify the identification information of the covering body 20. Thereafter, the target setting unit 10d sets the covering body 20 as a target object of monitoring. In this case, the target setting unit 10d sets an image of the covering body 20 as a monitoring target. Note that, after setting the covering body 20 as the target object of monitoring, the target setting unit 10d may set a region of a picture of the camera 4 including the image of the covering body 20 as a monitoring target.

As illustrated in FIG. 20, in step S201, the personal terminal 5 determines whether the reading unit 5f has read the covering body two-dimensional code 20a.

When the reading unit 5f has not read the covering body two-dimensional code 20a in step S201, the personal terminal 5 repeats the operation in step S201.

When the reading unit 5f has read the covering body two-dimensional code 20a in step S201, an operation in step S202 is performed. In step S202, the monitoring device 10 displays a video reflecting the covering body 20 on the use screen. The monitoring device 10 sets an image of the covering body 20 as a monitoring target.

Thereafter, an operation in step S203 is performed. Operations performed in step S203 and S204 are the same as the operations performed in steps S104 and S105 of the flowchart of FIG. 4.

After step S204, an operation in step S205 is performed. Operations performed in step S205 to step S209 are the same as the operations performed in step S108 to step S110 and the operations performed in steps S113 and S114 of the flowchart of FIG. 4. After step S207 or step S209, the monitoring system 1 ends the operation.

Note that, the operations performed in step S106 and step S107 and the operations performed in step S111 and step S112 of the flowchart of FIG. 4 may be performed between steps S204 and S205.

According to the second embodiment explained above, the monitoring system 1 includes the covering body 20. The monitoring device 10 detects a registered covering body 20 from a video of the camera 4. The monitoring device 10 sets, as a monitoring target, an image of the covering body 20 or a region of a picture including the image of the covering body 20. Therefore, an amount of arithmetic processing performed by the monitoring device 10 to detect a thing to be a target object from the video of the camera 4 decreases. As a result, accuracy of monitoring the target object is improved. The covering body 20 is placed on a thing desired to be monitored. Therefore, it is possible to watch relatively small things such as a wallet and a smartphone via the covering body 20. It is possible to watch a plurality of things via one covering body 20. As a result, an amount of arithmetic processing of the monitoring device 10 decreases.

Note that the monitoring system 1 may limit a thing that can be set as a target object of monitoring to only the covering body 20. In this case, it is possible to reduce an amount of arithmetic processing performed by the monitoring device 10 to detect a thing from a video of the camera 4. It is possible to improve accuracy of monitoring. It is possible to prevent the user from setting a thing of another person as a target object of monitoring without permission.

The covering body 20 has a specific pattern. Therefore, the monitoring device 10 can easily detect the covering body 20 from a video of the camera 4.

The covering body 20 includes the covering body two-dimensional code 20a indicating the covering body access information. When receiving the covering body access information from the personal terminal 5, the monitoring device 10 sets an image of the covering body 20 corresponding to the covering body access information or a region of a picture including the image of the covering body 20 as a monitoring target. Therefore, the user can set a target object simply by reading the covering body two-dimensional code 20a with the personal terminal 5. That is, the user does not need to access the use screen and designate a target object on the use screen or designate a region of a picture reflecting the target object. As a result, the user can use the baggage monitoring service via a simple user interface (UI). It is possible to improve comfortability of UX of the user in the baggage monitoring service.

### Third Embodiment

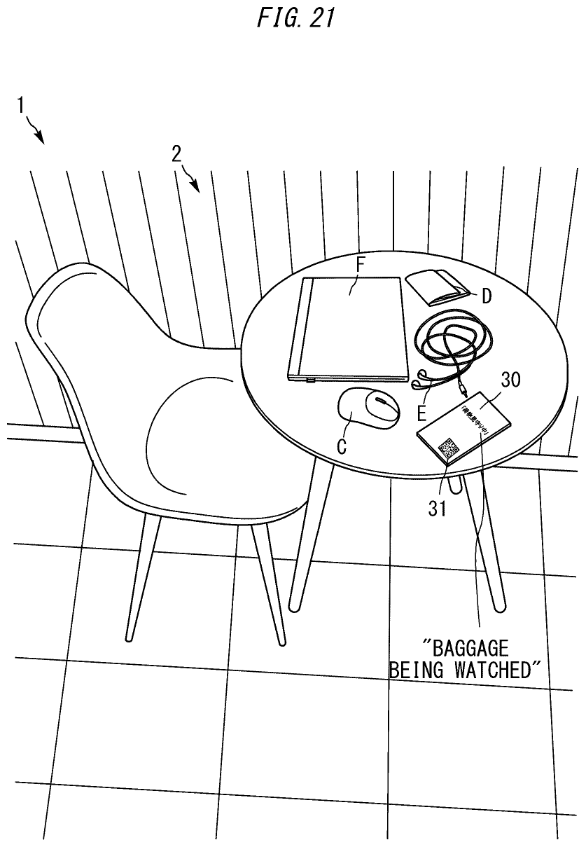

FIG. 21 is a diagram illustrating a monitoring tag of a monitoring system in a third embodiment. Note that portions that are the same as or equivalent to the portions in the first embodiment or the second embodiment are denoted by the same reference numerals and signs. Explanation of the portions is omitted.

As illustrated in FIG. 21, the monitoring system 1 further includes a plurality of monitoring tags 30. However, one of the plurality of monitoring tags 30 is illustrated in FIG. 21.

For example, each of the plurality of monitoring tags 30 is a plate having a specific pattern. For example, characters “baggage being watched” are described on each of the plurality of monitoring tags 30. The plurality of monitoring tags 30 are prepared in the store 2. Each of the plurality of monitoring tags 30 has a tag two-dimensional code 31. For example, the tag two-dimensional code 31 is a QR code (registered trademark). The tag two-dimensional code 31 indicates tag access information. For example, the tag access information is information with which a URL for accessing the monitoring device 10 and identification information of the monitoring tag 30 are associated.

Although not illustrated in FIG. 21, the monitoring device 10 analyzes a pattern of the monitoring tag 30 reflected in a video of the camera 4 to detect the monitoring tag 30. The monitoring device 10 displays, on the use screen, a list of the plurality of monitoring tags 30 prepared in the store 2. The monitoring device 10 displays, on the use screen, a list of the plurality of monitoring tags 30 prepared in the store 2. Information indicating whether each of the plurality of monitoring tags 30 is used by another user is also displayed in the list of the plurality of monitoring tags 30. The user selects, on the use screen displayed on the personal terminal 5, the monitoring tag 30 placed by the user. The monitoring device 10 displays, on the use screen, a video of the camera 4 reflecting the selected monitoring tag 30. The user can designate, as a target object of monitoring, a thing present within a specified distance from the monitoring tag 30 among things reflected on the use screen.

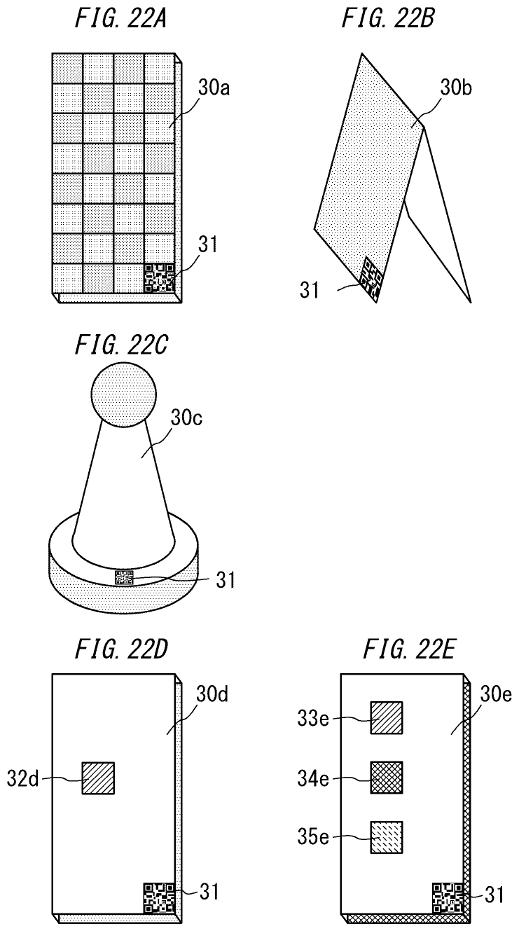

Subsequently, an example of the monitoring tag 30 is explained with reference to FIG. 22.

FIG. 22 is a diagram illustrating the monitoring tag of the monitoring system in the third embodiment.

FIG. 22 illustrates monitoring tags 30a, 30b, 30c, 30d, and 30e respectively as examples of the monitoring tag 30.

As illustrated in (a) of FIG. 22, the monitoring tag 30a is a monitoring tag identified by a specific pattern. When a plurality of monitoring tags 30a are present, the plurality of monitoring tags 30a respectively have specific patterns.

As illustrated in (b) and (c) of FIG. 22, the monitoring tag 30b and the monitoring tag 30c are monitoring tags identified by specific colors and specific shapes. Specifically, for example, the monitoring tag 30b is formed by bending one plate into two. The monitoring tag 30c has a shape of a color cone (registered trademark).

As illustrated in (d) of FIG. 22, the monitoring tag 30d has a light source 32d. For example, the light source 32d is an LED. The monitoring tag 30d is a monitoring tag identified by a flickering pattern of the light source 32d. Note that the light source 32d may be a light source that emits lights having a plurality of colors.

As illustrated in (e) of FIG. 22, the monitoring tag 30e includes a first light source 33e, a second light source 34e, and a third light source 35e. For example, the first light source 33e, the second light source 34e, and the third light source 35e are LEDs. All of the first light source 33e, the second light source 34e, and the third light source 35e emit yellow, red, and green lights. The monitoring tag 30e is a monitoring tag identified by flickering patterns of the first light source 33e, the second light source 34e, and the third light source 35e.

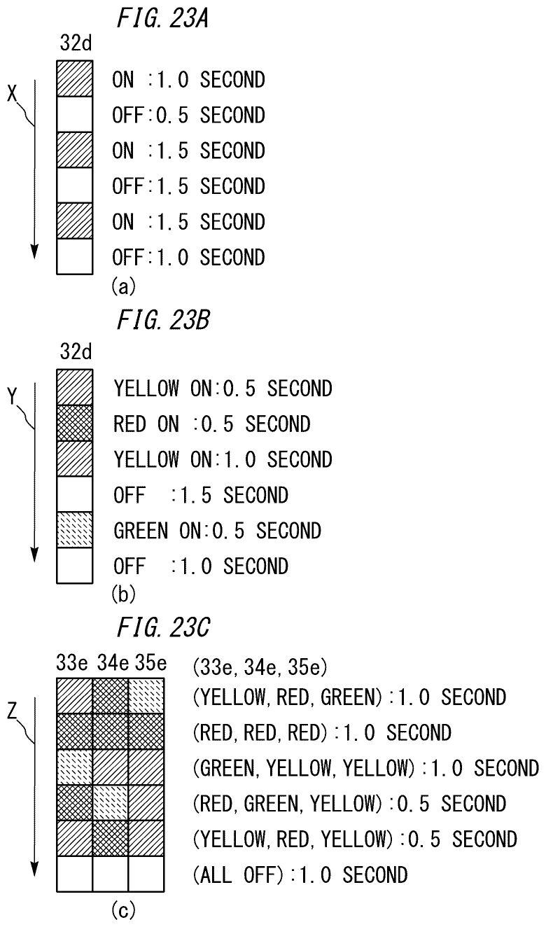

Subsequently, an example of flickering patterns of the monitoring tags 30d and 30e is explained with reference to FIG. 23.

FIG. 23 is a diagram illustrating flickering patterns of lights emitted by the monitoring tags of the monitoring system in the third embodiment.

FIG. 23 illustrates three flickering patterns (a), (b), and (c) as examples of the flickering patterns. (a), (b), and (c) of FIG. 23 respectively illustrate patterns of one cycle of the flickering patterns (a), (b), and (c). For example, the flickering patterns (a), (b), and (c) are repeated a specified number of times.

(a) of FIG. 23 illustrates the flickering pattern (a) of the light source 32d of the monitoring tag 30d. The flickering pattern (a) is a pattern of light of one color being turned on or off. The light source 32d is turned on or off for specific times in order indicated by an arrow X. For example, a row of “On: 1.0 second” indicates that the light source 32d is continuously turned on for 1.0 second.

(b) of FIG. 23 illustrates the flickering pattern (b) of the light source 32d that emits light of a plurality of colors. The flickering pattern (b) is a pattern of light of any one of yellow, red, and green being turned on or off. The light source 32d is turned on and off in specific colors and for specific times in order indicated by an arrow Y. For example, a row of “Yellow on: 0.5 second” indicates that the light source 32d is continuously turned on in yellow for 0.5 second.

(c) of FIG. 23 illustrates the flickering pattern (c) of the first light source 33e, the second light source 34e, and the third light source 35e of the monitoring tag 30e. The flickering pattern (c) is a pattern of a plurality of light sources being turned on or off in order of specific colors. The first light source 33e, the second light source 34e, and the third light source 35e are turned on or off in specific colors and for specific times in order indicated by an arrow Z as in a combination indicated by (the first light source 33e, the second light source 34e, and the third light source 35e). For example, a row of “(Yellow, red, green): 1.0 second” indicates that a state in which the light source 33e is turned on in yellow, the second light source 34e is turned on in red, and the third light source is turned on in green lasts for 1.0 second. For example, a row of “(all off): 1.0 second” indicates that a state in which the first light source 33e is turned off, the second light source 34e is turned off, and the third light source is turned off lasts for 1.0 second.

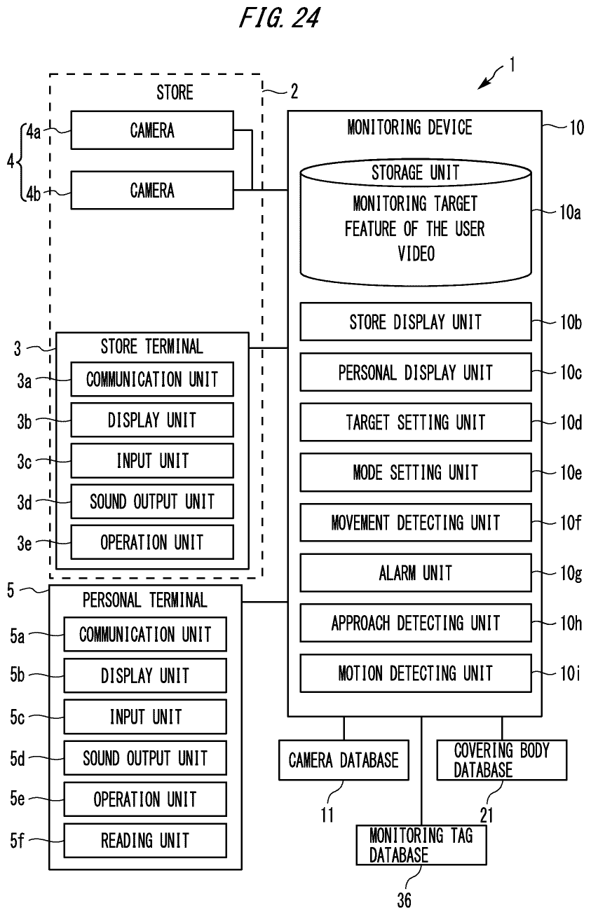

Subsequently, the monitoring system 1 is explained with reference to FIG. 24.

FIG. 24 is a block diagram of the monitoring system in the third embodiment.

As illustrated in FIG. 24, the monitoring system 1 further includes a monitoring tag database 36. Note that, in FIG. 24, the monitoring tag 30 is not illustrated.

For example, a storage medium storing the monitoring tag database 36 is provided in the same building as the building in which the monitoring device 10 is provided. The monitoring tag database 36 stores monitoring tag information with which identification information of the monitoring tag 30 registered in the monitoring system 1, identification information of the store 2 where the monitoring tag 30 is prepared, and information for identifying the monitoring tag 30 are associated. The information for identifying the monitoring tag 30 is information indicating a pattern of the monitoring tag 30a, information indicating combinations of shapes and patterns of the monitoring tags 30b and 30c, information indicating flickering patterns of the monitoring tags 30d and 30e, and the like.

The target setting unit 10d analyzes, based on the monitoring tag information of the monitoring tag database 36, an image of the monitoring tag 30 reflected on the camera 4 to specify identification information of the monitoring tag 30. The target setting unit 10d can set, as a target object corresponding to the monitoring tag 30, only a thing present in a position within a specified distance from the monitoring tag 30. That is, the target setting unit 10d does not set, as a target object corresponding to the monitoring tag 30, a thing present in a position apart from the monitoring tag 30 more than the specified distance. Specifically, the target setting unit 10d does not set, as a monitoring target, an image of a thing further apart from the monitoring tag 30 more than the specified distance. Alternatively, the target setting unit 10d does not set, as a monitoring target, a region of a picture including an image of a thing apart from the monitoring tag 30 more than the specified distance. At this time, for example, the target setting unit 10d does not set, as the monitoring target, a region farther from an image of the monitoring tag 30 than a distance on a specified picture not to set, as a monitoring target, a region of a picture including an image of a thing apart from the monitoring tag 30 more than the specified distance.

When the monitoring device 10 has been accessed from the personal terminal 5, the personal display unit 10c specifies the store 2 where the personal terminal 5 is present. The personal display unit 10c displays, on the use screen, a list of the monitoring tags 30 prepared in the specified store 2. At this time, the personal display unit 10c displays, in association with the monitoring tag 30, whether the monitoring tag 30 is used by another user. When the monitoring tag 30 has been selected on the use screen, the personal display unit 10c displays, on the use screen, a video of the camera 4 reflecting the selected monitoring tag 30.

Subsequently, an operation performed in the baggage monitoring service in the third embodiment is explained with reference to FIG. 24.

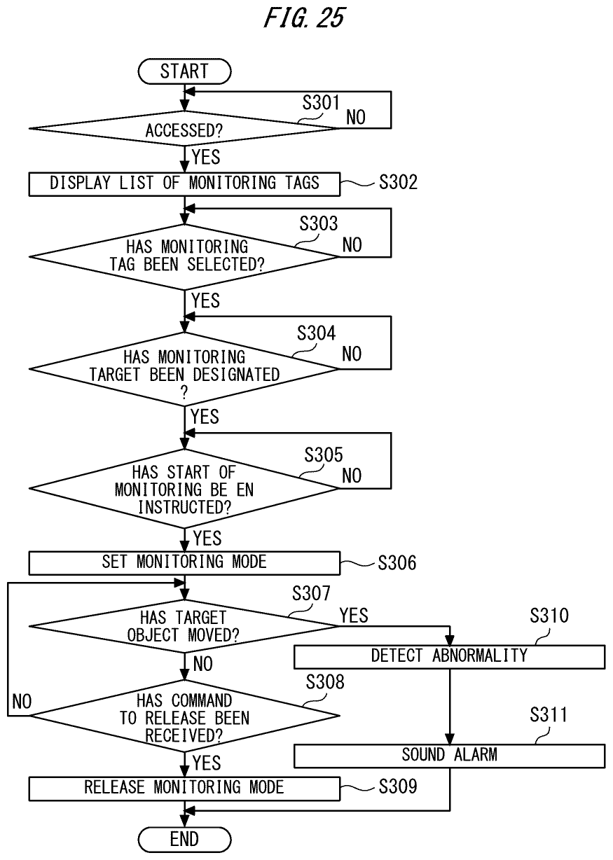

FIG. 25 is a flowchart for explaining an overview of an operation of the monitoring system in the third embodiment.

As illustrated in FIG. 25, in step S301, the personal display unit 10c of the monitoring device 10 determines whether the baggage monitoring service has been accessed from the personal terminal 5.

When the baggage monitoring service has not been accessed from the personal terminal 5 in step S301, the personal display unit 10c repeats the operation in step S301.

When it is determined in step S301 that the baggage monitoring service has been accessed, an operation in step S302 is performed. In step S302, the personal display unit 10c displays, on the use screen of the personal terminal 5, the list of the plurality of monitoring tags 30 prepared in the store 2.

Thereafter, an operation in step S303 is performed. In step S303, the personal display unit 10c determines which monitoring tag 30 has been selected out of the list.

When it is determined in step S303 that the monitoring tag 30 has not been selected, the operation in step S303 is repeated.

When the monitoring tag 30 has been selected in step S303, an operation in step S304 is performed. In step S304, the personal display unit 10c displays, on the use screen of the personal terminal 5, a video reflecting the selected monitoring tag 30. Thereafter, the personal display unit 10c determines whether a monitoring target has been selected. At this time, the target setting unit 10d does not receive an instruction to designate, as a monitoring target, an image of a thing present in a position apart from the selected monitoring tag 30 more than a specified distance or a region of a picture including the image of the thing.

When a monitoring target has not been designated in step S304, the operation in step 304 is continued.

When a monitoring target has been designated in step S304, operations in step S305 and subsequent steps are performed. Operations performed in steps S305 to S311 are the same as the operations performed in steps S203 to S209 of the flowchart of FIG. 20 in the second embodiment.

According to the third embodiment explained above, the monitoring system 1 includes the plurality of monitoring tags 30. The monitoring device 10 causes the personal terminal 5 to display the use screen for receiving selection of any one of the plurality of monitoring tags 30. Therefore, the user can easily select the monitoring tag 30.

The monitoring device 10 does not set, as a monitoring target, an image of a thing present in a position apart from the monitoring tag 30 more than the specified distance or a region of a picture including the image of the thing. Therefore, it is possible to prevent the user from erroneously setting a thing of another person as a target object.

The monitoring tag 30 includes a specific shape and a specific pattern. The monitoring device 10 identifies the monitoring tag 30 based on a shape and a pattern of the monitoring tag 30 reflected on a video of the camera 4. Therefore, the monitoring device 10 can specify, without the camera 4 being selected by the user, the camera 4 that photographs the monitoring tag 30 to be used. As a result, convenience of the baggage monitoring service is improved.

The monitoring tag 30 includes one or more light sources that are turned on in specific flickering patterns. The monitoring device 10 identifies the monitoring tag 30 based on a flickering pattern of the monitoring tag 30 reflected on a video of the camera 4. Therefore, the monitoring device 10 can specify, without the camera 4 being selected by the user, the camera 4 that photographs the monitoring tag 30 to be used. As a result, convenience of the baggage monitoring service is improved.

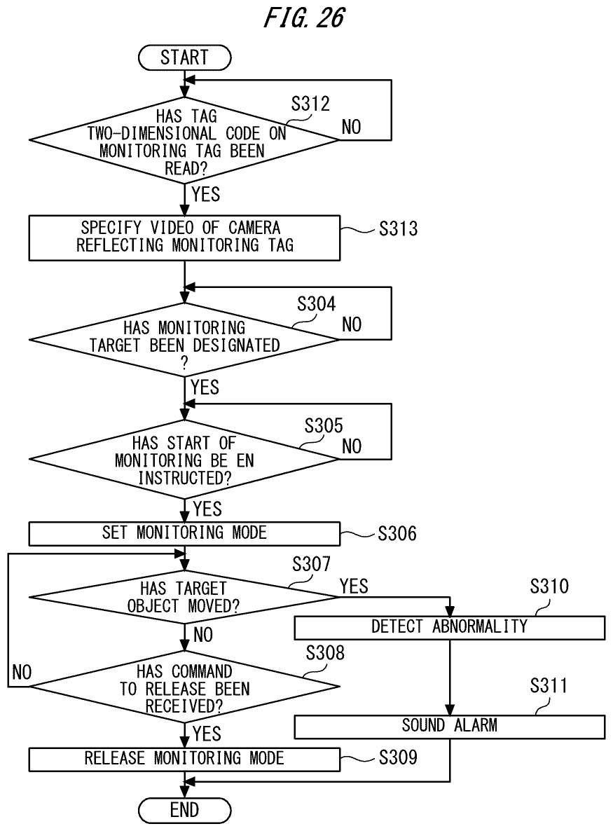

Subsequently, a first modification of the third embodiment is explained with reference to FIG. 26.

FIG. 26 is a flowchart for explaining an overview of an operation of the first modification of the monitoring system in the third embodiment.

In the first modification of the third embodiment, the user reads, with the personal terminal 5, the tag two-dimensional code 31 of the monitoring tag 30. The reading unit 5f of the personal terminal 5 acquires tag access information from an image of the tag two-dimensional code 31. The personal terminal 5 accesses the monitoring device 10 based on the tag access information. At this time, the personal terminal 5 transmits the tag access information to the monitoring device 10.

When the monitoring device 10 has received the tag access information, the target setting unit 10d of the monitoring device 10 specifies, based on the monitoring tag information, the camera 4 reflecting the monitoring tag 30 corresponding to the tag access information. The personal display unit 10c displays, based on the tag access information, on the use screen accessed by the personal terminal 5, a video of the camera 4 reflecting the monitoring tag 30.

As illustrated in FIG. 26, in step S312 of the flowchart, the personal terminal 5 determines whether the tag two-dimensional code 31 has been read.

When the tag two-dimensional code 31 has not been read in step S312, the personal terminal 5 repeats the operation in step S312.

When it is determined in step S312 that the tag two-dimensional code 31 has been read, an operation in step S313 is performed. In step S313, the personal terminal 5 transmits the tag access information to the monitoring device 10. The target setting unit 10d of the monitoring device 10 specifies a video of the camera 4 reflecting the monitoring tag 30. The personal display unit 10c displays, on the use screen of the personal terminal 5, the video of the camera 4 reflecting the monitoring tag 30.

Thereafter, operations in step S304 and subsequent steps are performed. Step S304 to step S311 are the same as step S304 to step S311 in the flowchart of FIG. 25.

According to the first modification of the third embodiment explained above, the monitoring tag 30 includes the tag two-dimensional code 31. When the tag two-dimensional code 31 has been read, the personal terminal 5 accesses the monitoring device 10. At this time, the personal terminal 5 transmits the tag access information indicated by the tag two-dimensional code 31 to the monitoring device 10. The monitoring device 10 displays, on the use screen, the video of the camera 4 reflecting the monitoring tag 30 indicating the tag access information. That is, the monitoring device 10 specifies, without receiving selection out of the plurality of monitoring tags 30 on the use screen, the monitoring tag 30 to be used by the user. Therefore, convenience of the user is improved.

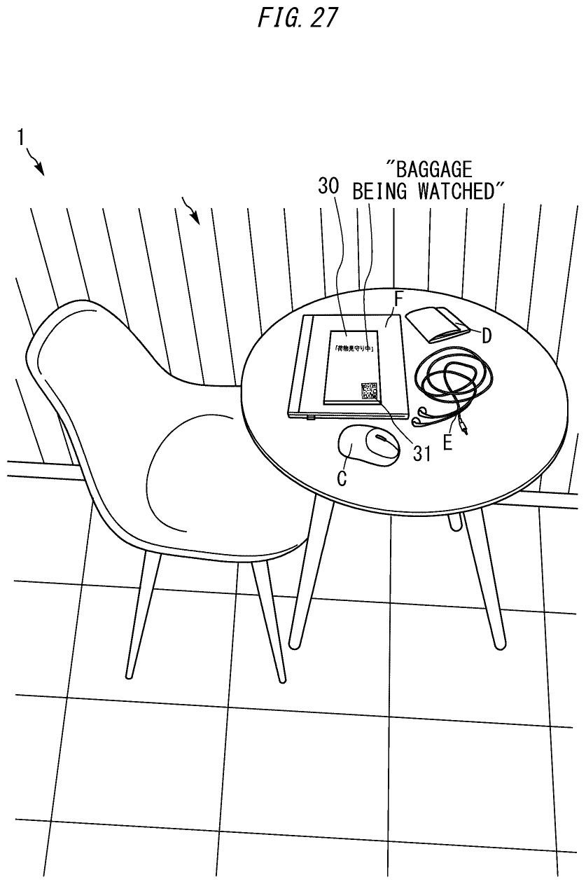

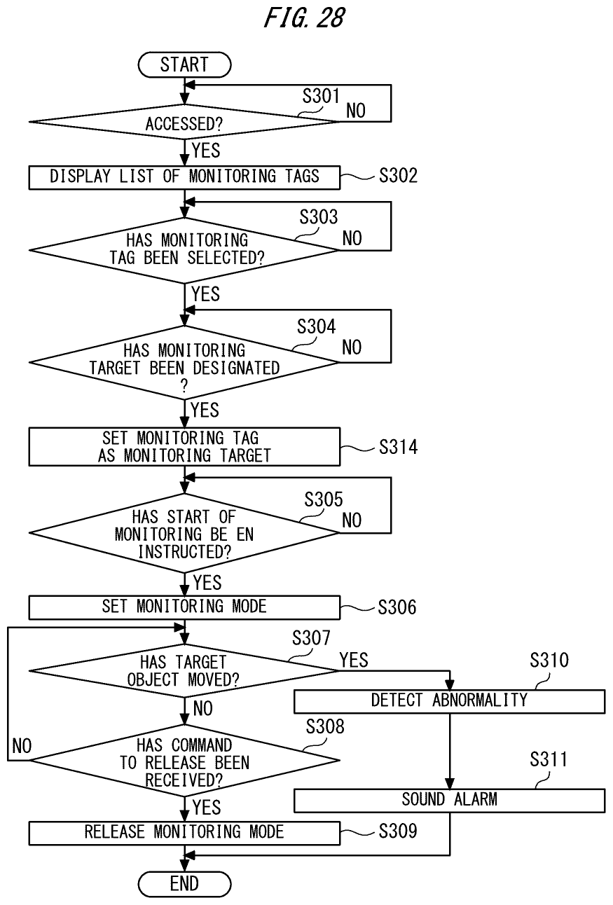

Subsequently, a second modification of the monitoring system 1 in the third embodiment is explained with reference to FIG. 27 and FIG. 28.

FIG. 27 is a diagram illustrating a monitoring tag of the second modification of the monitoring system in the third embodiment. FIG. 28 is a flowchart for explaining an overview of an operation of the second modification of the monitoring system in the third embodiment.

As illustrated in FIG. 27, in the second modification of the third embodiment, the user places the monitoring tag 30 on a thing desired to be monitored. The user operates the personal terminal 5 to designate the monitoring tag 30 as a target object of monitoring. Although not illustrated, at this time, when a certain monitoring tag 30 has been selected in the list of the monitoring tags 30 on the use screen, the monitoring device 10 sets the monitoring tag 30 as the target object. In this case, the monitoring device 10 sets, as a monitoring target, an image of the monitoring tag 30 in a picture of the camera 4. Note that the monitoring device 10 may set, as the monitoring target, a region of a picture including the image of the monitoring tag 30 in the picture of the camera 4.

For example, when a thing present under the monitoring tag 30 set as the target object has moved, the monitoring tag 30 moves together with the thing. In this case, the monitoring device 10 detects an abnormality.

In FIG. 28, steps S301 to S303 are the same as steps S301 to S303 of the flowchart of FIG. 25.

When the monitoring tag 30 has been selected from the list of the monitoring tags 30 in step S303, an operation in step S314 is performed. In step S314, the target setting unit 10d of the monitoring device 10 sets, as a monitoring target, an image of the selected monitoring tag 30 or a region of a picture including the image of the monitoring tag 30. The personal display unit 10c displays, on the use screen, a video of the camera 4 reflecting the selected monitoring tag 30.

Thereafter, operations in step S305 and subsequent steps are performed. Steps S305 to S311 are the same as steps S305 to S311 of the flowchart of FIG. 25.

According to the second modification of the third embodiment explained above, the monitoring device 10 sets, as a target object, the monitoring tag 30 selected on the use screen of the personal terminal 5 and sets, as a monitoring target, an image of the monitoring tag 30 or a region of a picture including the image of the monitoring tag 30. Therefore, the user can set the target object without specifically selecting a thing desired to be monitored. For example, when the monitoring tag 30 placed on the thing desired to be monitored has been set as a target object, the same monitoring effect as the monitoring effect in a state in which the thing desired to be monitored is watched is generated. As a result, it is possible to improve convenience of the user.

Note that, when receiving tag access information, the monitoring device 10 may set, as a target object, the monitoring tag 30 corresponding to the tag access information and set, as a monitoring target, an image of the monitoring tag 30 or a region of a picture including the image of the monitoring tag 30. Therefore, the user can set the target object without selecting a thing desired to be monitored.

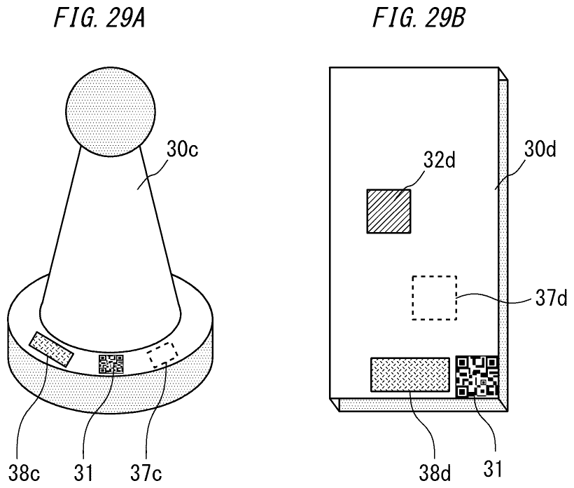

Subsequently, a third modification of the monitoring system 1 in the third embodiment is explained with reference to FIG. 29 to FIG. 31.

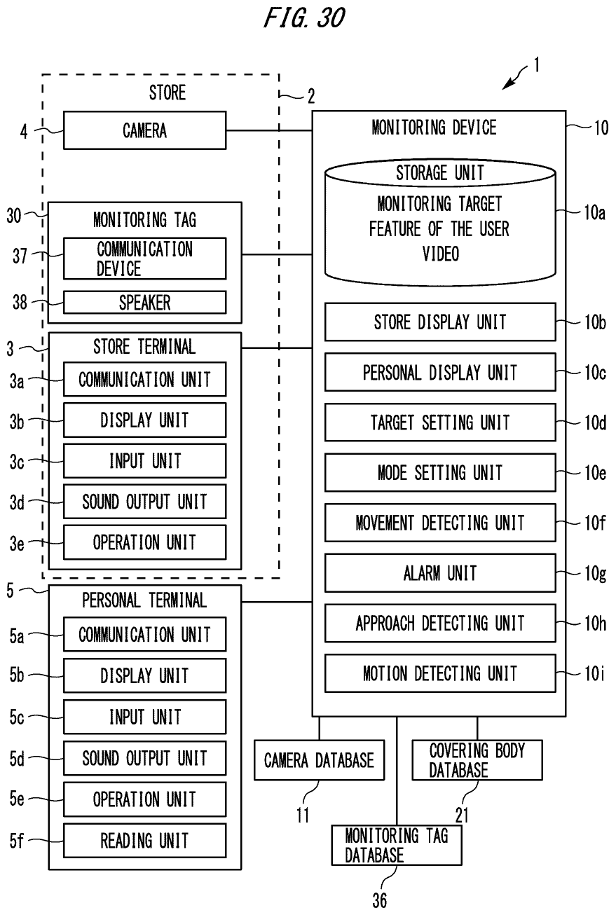

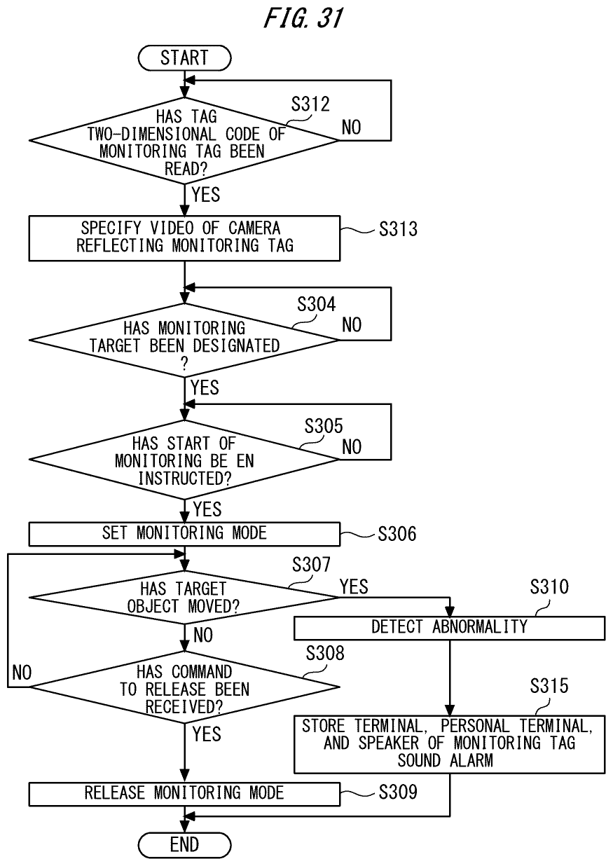

FIG. 29 is a diagram illustrating a monitoring tag of the third modification of the monitoring system in the third embodiment. FIG. 30 is a block diagram of the third modification of the monitoring system in the third embodiment. FIG. 31 is a flowchart for explaining an overview of an operation of the third modification of the monitoring system in the third embodiment.

FIG. 29 illustrates the monitoring tags 30c and 30d as examples of the monitoring tag 30.

As illustrated in (a) of FIG. 29, the monitoring tag 30c further includes a communication device 37c and a speaker 38c. The communication device 37c communicates with the monitoring device 10 not illustrated in FIG. 29 via a network. The speaker 38c emits sound.

As illustrated in (b) of FIG. 29, the monitoring tag 30d further includes a communication device 37d and a speaker 38d. The communication device 37d communicates with the monitoring device 10 via the network. The speaker 38d emits sound.

As illustrated in FIG. 30, in the third modification, the monitoring tag 30 is not limited to a shape illustrated in FIG. 29 and further includes a communication device 37 and a speaker 38.

When detecting an abnormality, that is, when transmitting a command to emit an alarm to the store terminal 3 and the personal terminal 5, the alarm unit 10g transmits the command to emit an alarm to the communication device 37 of the monitoring tag 30. Note that the monitoring tag 30 to which the alarm unit 10g transmits the command is the monitoring tag 30 selected on the use screen or the monitoring tag 30 set as a target object.

When receiving the command, the communication device 37 causes the speaker 38 to sound an alarm.

A flowchart in the case in which the user accesses the monitoring system 1 via the tag two-dimensional code 31 is illustrated in FIG. 31. Steps S312 to S309 are the same as steps S312 to S309 of the flowchart of FIG. 26. Step S310 is the same as step S310 of the flowchart of FIG. 26.

After the operation in step S310 has been performed, an operation in step S315 is performed. In step S315, the alarm unit 10g of the monitoring device 10 further transmits, to the monitoring tag 30, a command to emit an alarm to the effect that the abnormality has occurred in the target object. The store terminal 3, the personal terminal 5, and the speaker 38 of the monitoring tag 30 sound an alarm. Thereafter, the monitoring system 1 ends the operation.

According to the third modification of the third embodiment explained above, the monitoring tag 30 includes the speaker 38. When detecting an abnormality of the target object, the monitoring device 10 causes the speaker 38 to sound an alarm. At this time, the speaker 38 is the speaker 38 of the monitoring tag 30 selected on the use screen or the speaker 38 of the monitoring tag 30 set in the target object. Therefore, it is possible to inform people around the monitoring tag 30 that the abnormality has occurred. As a result, it is possible to exert a crime prevention effect even if the user and an employee of the store 2 are absent near the monitoring tag 30.

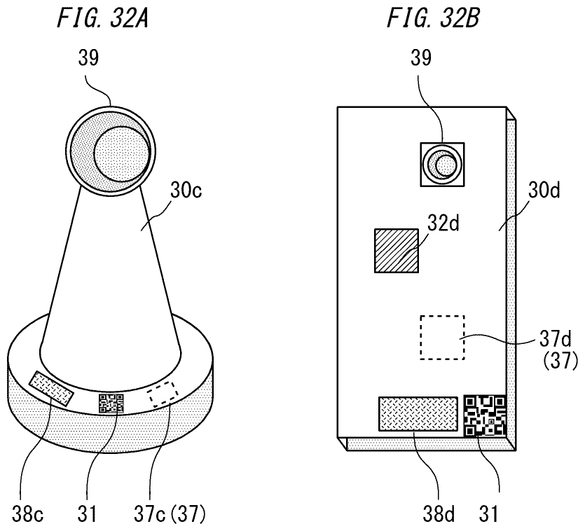

Subsequently, a fourth modification of the monitoring system 1 in the third embodiment is explained with reference to FIG. 32 to FIG. 34.

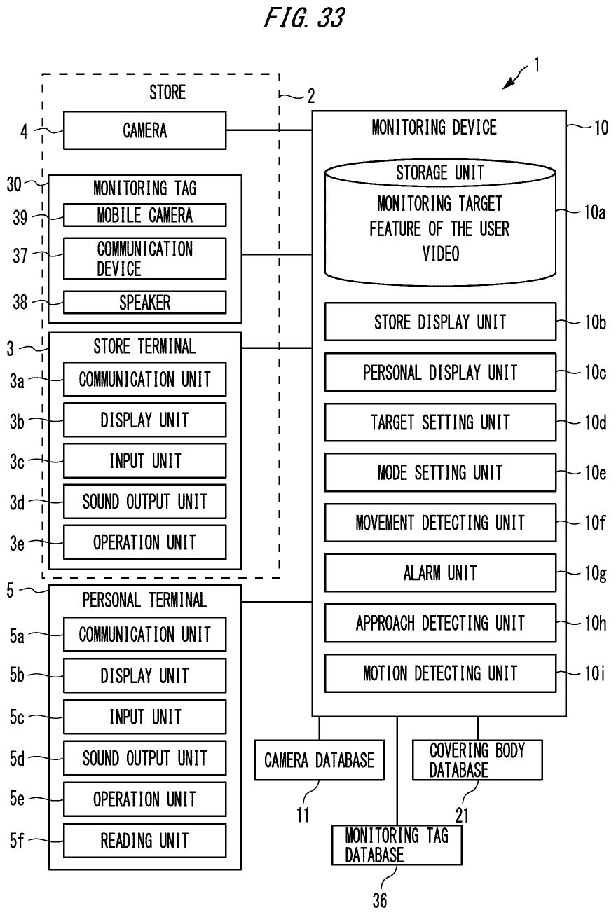

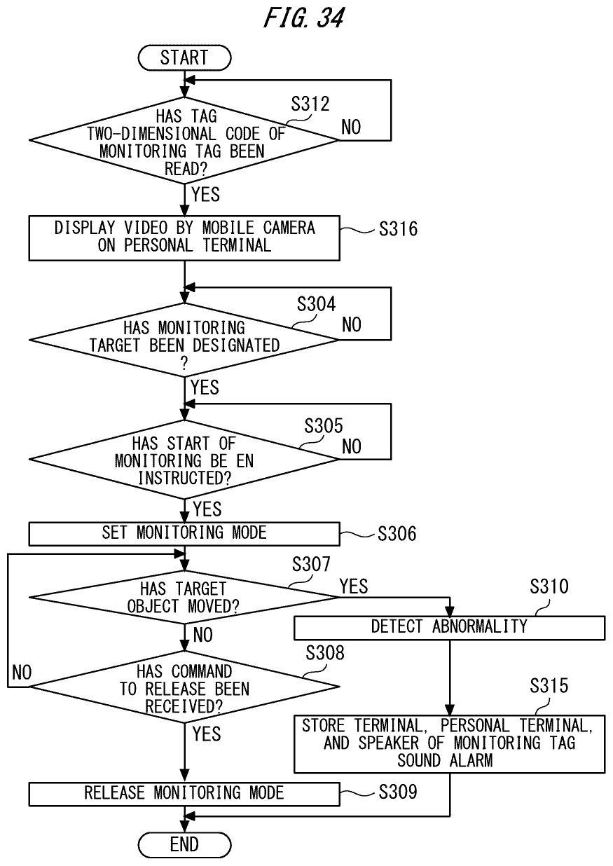

FIG. 32 is a diagram illustrating a monitoring tag of the fourth modification of the monitoring system in the third embodiment. FIG. 33 is a block diagram of the fourth modification of the monitoring system in the third embodiment. FIG. 34 is a flowchart for explaining an overview of an operation of the fourth modification of the monitoring system in the third embodiment.

As illustrated in FIG. 32, in the fourth modification of the third embodiment, the monitoring system 1 further includes a mobile camera 39.

The mobile camera 39 is provided in the monitoring tag 30. (a) and (b) of FIG. 32 respectively illustrate the monitoring tags 30c and 30d in which the mobile camera 39 is provided. The mobile camera 39 is a camera capable of photographing a wide range. Specifically, for example, the mobile camera 39 is a 360-degree camera and a wide angle camera. The mobile camera 39 transmits information of a photographed video to the monitoring device 10 via the communication device 37.

The user installs the monitoring tag 30 such that the mobile camera 39 can photograph a thing desired to be watched.

The monitoring device 10 uses a video from the mobile camera 39 in the same manner as a video of the camera 4. That is, the user can operate the use screen based on a video photographed by the mobile camera 39.

Note that, although not illustrated, in the store 2, the camera 4 may not be installed and only the mobile camera 39 may be prepared.

In FIG. 33, the camera database 11 stores information including information concerning the mobile camera 39. Specifically, the camera database 11 stores information with which identification information of the mobile camera 39, identification information of the monitoring tag 30 in which the mobile camera 39 is provided, and information concerning the store where the mobile camera 39 is installed are associated.

The store display unit 10b can display a video of the camera 4 or a video of the mobile camera 39 on the store use screen of the store terminal 3.

In FIG. 34, a flowchart in the case in which the user accesses the monitoring system 1 via the tag two-dimensional code 31 is illustrated.

Step S312 is the same as step S312 of the flowchart of FIG. 31.

When it is determined in step S312 that the tag two-dimensional code 31 has been read, an operation in step S316 is performed. In step S316, the personal display unit 10c specifies, based on information stored by the camera database 11, the mobile camera 39 corresponding to the tag two-dimensional code 31. The personal display unit 10c displays, on the use screen of the personal terminal 5, a video photographed by the mobile camera 39 corresponding to the tag two-dimensional code 31.

Thereafter, the operations in steps S304 to S315 are performed. Steps S304 to S315 are the same as steps S304 to S315 in FIG. 31.

According to the fourth modification of the third embodiment explained above, the monitoring tag 30 includes the mobile camera 39. A video of the mobile camera 39 is treated in the same manner as a video of the camera 4. That is, the monitoring system 1 executes the baggage monitoring service using the video of the mobile camera 39. Therefore, the monitoring system 1 can provide the baggage monitoring service in a store where the camera 4 is not installed in advance. That is, when introducing the baggage monitoring service, it is unnecessary to perform installation work for a new camera. A manager of a store can easily introduce the baggage monitoring service into the store. In a seat far from the position of the camera 4 installed in advance, the mobile camera 39 can photograph a target object from a short distance. Therefore, in various cases such as a case in which the resolution of the camera 4 is low, a case in which a target object is present in a place far from the camera 4, or a case in which a target object is present in a place where the camera 4 cannot photograph the target object, the monitoring device 10 can use a video clearly reflecting the target object. As a result, it is possible to improve accuracy of monitoring the target object.

### Fourth Embodiment

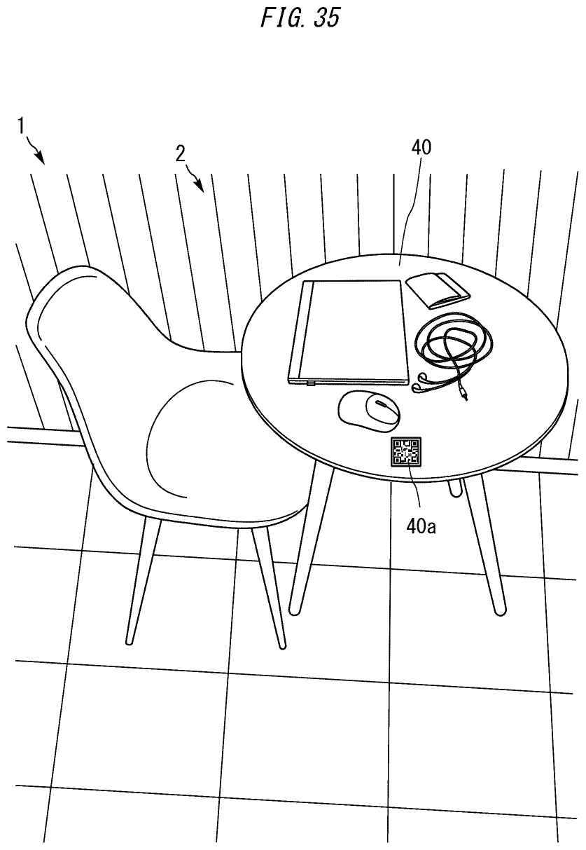

FIG. 35 is a diagram illustrating a desk of a monitoring system in a fourth embodiment. Note that portions that are the same as or equivalent to the portions in any one of the first to third embodiments are denoted by the same reference numerals and signs. Explanation of the portions is omitted.

As illustrated in FIG. 35, in the fourth embodiment, the monitoring system 1 includes a plurality of desks 40. In FIG. 35, one of the plurality of desks 40 is illustrated. The plurality of desks 40 are installed in the store 2. The plurality of desks 40 respectively include desk two-dimensional codes 40a. For example, the desk two-dimensional codes 40a are QR codes (registered trademark). The desk two-dimensional codes 40a indicate desk access information. For example, the desk access information is information with which a URL for accessing the monitoring device 10 and identification information of the desk 40 are associated.

When using the baggage monitoring service while using a certain desk 40, a user reads the desk two-dimensional code 40a of the desk 40 with the personal terminal 5. The monitoring device 10 not illustrated in FIG. 35 displays, on the use screen, a video of the camera 4 reflecting the desk 40. The monitoring device 10 can set, as a target object of monitoring, only a thing present within a specified distance from the desk 40.

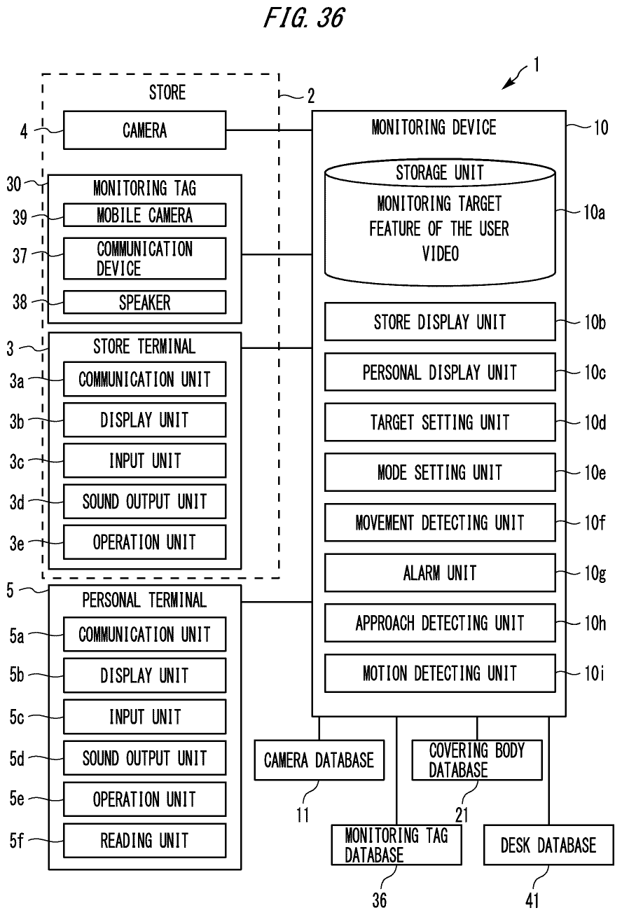

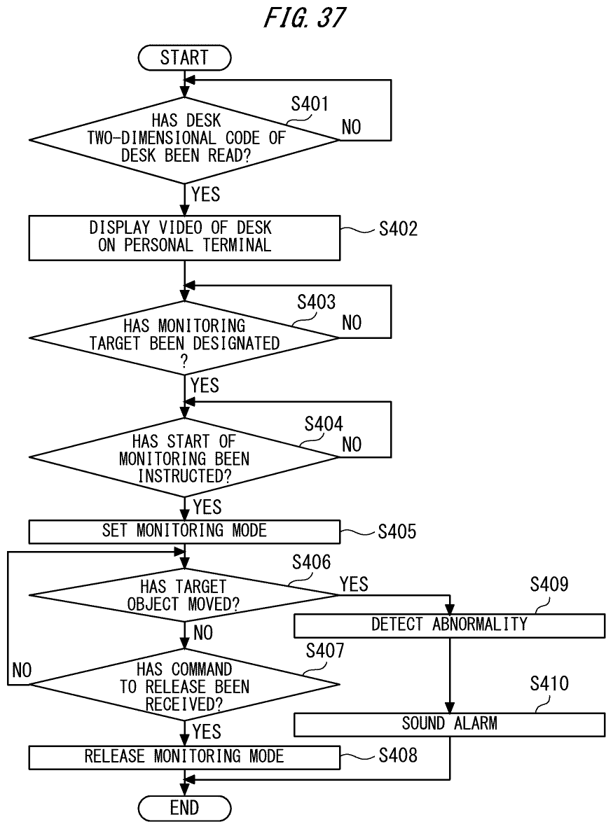

Subsequently, the monitoring system 1 in the fourth embodiment is explained with reference to FIG. 36 and FIG. 37.

FIG. 36 is a block diagram of the monitoring system in the fourth embodiment. FIG. 37 is a flowchart for explaining an overview of an operation of the monitoring system in the fourth embodiment.

As illustrated in FIG. 36, the monitoring system 1 further includes a desk database 41. Note that the desk 40 is not illustrated in FIG. 36.

For example, a storage medium storing the desk database 41 is provided in the same building as a building in which the monitoring device 10 is provided. The desk database 41 stores desk information with which identification information of the desk 40 registered in the monitoring system 1, identification information of the store 2 where the desk 40 is installed, and information for identifying the desk 40 are associated. For example, the information for identifying the desk 40 is information of a seat number of the desk 40, information of a position of the desk 40 on the inside of the store 2, information of a pattern of the desk 40, and the like.

When the monitoring device 10 has received desk access information, the target setting unit 10d specifies, based on the desk information of the desk database 41, the camera 4 that photographs the desk 40 corresponding to the desk information. The target setting unit 10d can set, as a target object corresponding to the desk 40, only a thing present in a position within a specified distance from the desk 40. That is, the target setting unit 10d does not set, as a monitoring target corresponding to the desk 40, an image of a thing present in a position apart from the desk 40 more than the specified distance. The target setting unit 10d does not set, as the monitoring target, a region of a picture including the image of the thing present in the position apart from the desk 40 more than the specified distance. At this time, for example, the target setting unit 10d does not set, as the monitoring target, a region farther from an image of the desk 40 more than a specified distance on an image not to set, as the monitoring target, the region of the picture including the image of the thing apart from the desk 40 more than the specified distance.

As illustrated in the flowchart of FIG. 37, in step S401, the personal terminal 5 determines whether the desk two-dimensional code 40a has been read.

When the desk two-dimensional code 40a has not been read in step S401, the personal terminal 5 repeats the operation in step S401.

When it is determined in step S401 that the desk two-dimensional code 40a has been read, an operation in step S402 is performed. In step S402, the personal terminal 5 transmits desk access information to the monitoring device 10. The target setting unit 10d of the monitoring device 10 specifies the camera 4 that photographs the desk 40 corresponding to the desk access information. The personal display unit 10c displays a video of the specified camera 4 on the use screen of the personal terminal 5.

Thereafter, an operation in step S403 is performed. In step S403, the target setting unit 10d determines whether a monitoring target has been designated. At this time, the target setting unit 10d receives designation of a monitoring target for only a thing present within a specified distance from the desk 40.

When a monitoring target has not been designated in step S403, the operation in step S403 is repeated.

When a monitoring target has been designated in step S403, operations in step S404 and subsequent steps are performed. Here, operations performed in steps S404 to S410 are the same as the operations performed in steps S305 to S311 in the flowchart of FIG. 25 in the third embodiment.

According to the fourth embodiment explained above, the monitoring system 1 includes the plurality of desks 40. The plurality of desks 40 respectively include the desk two-dimensional codes 40a. When receiving desk access information from the personal terminal 5, the monitoring device 10 causes the use screen of the personal terminal 5 to display a video of the camera 4 that photographs the desk 40 corresponding to the desk access information. Therefore, the user can easily access the use screen. As a result, convenience of the user is improved.

The monitoring device 10 does not set, as a monitoring target, an image of a thing present in a position apart from the desk 40 corresponding to the desk access information more than the specified distance or a region of a picture including the image of the thing. Therefore, it is possible to prevent the user from erroneously set a thing of another person as a target object.

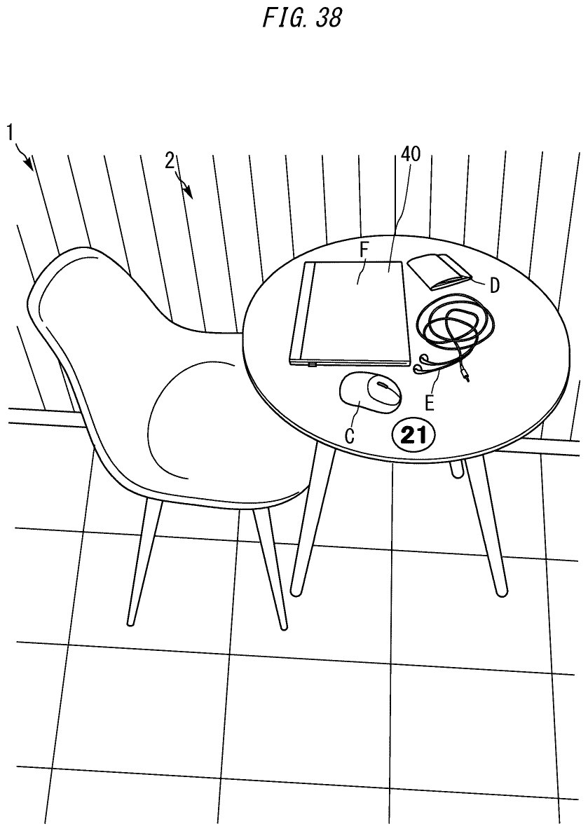

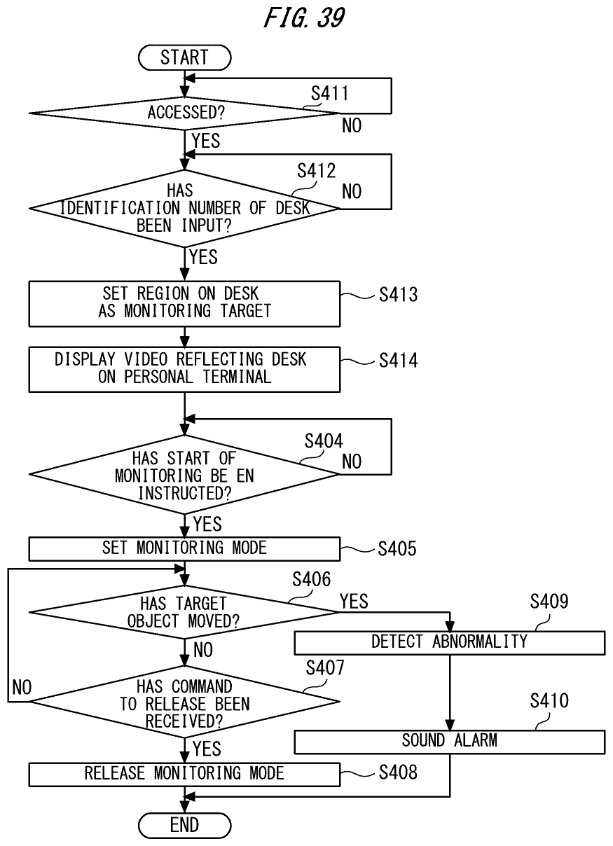

Subsequently, a first modification of the monitoring system 1 in the fourth embodiment is explained with reference to FIG. 38 and FIG. 39.

FIG. 38 is a diagram illustrating a desk of the first modification of the monitoring system in the fourth embodiment. FIG. 39 is a flowchart for explaining an overview of an operation of the first modification of the monitoring system in the fourth embodiment.

As illustrated in FIG. 38, in each of the plurality of desks 40, information for identifying the desk 40 is provided. For example, in each of the plurality of desks 40, an identification number of the desk 40 is described.

Although not illustrated, the user inputs, to the use screen of the personal terminal 5, an identification number of the desk 40 that the user occupies. The personal display unit 10c of the monitoring device 10 receives the input of the identification number of the desk 40 from the use screen of the personal terminal 5.

Although not illustrated, the target setting unit 10d of the monitoring device 10 specifies, based on the desk information stored by the desk database 41, the camera 4 that photographs the desk 40 corresponding to the input identification number. The target setting unit 10d detects a specified region set on the desk 40. For example, the specified region is an entire region on the desk. In this case, the target setting unit 10d sets, as a monitoring target, the specified region in a picture of the camera 4. At this time, a thing to be a target object is present in the specified region.

Note that the target setting unit 10d may set, as a monitoring target, an image of a thing present on the inside of the specified region set on the desk 40. In this case, the target setting unit 10d detects a plurality of things C, D, E, and F present on the inside of the specified region. The target setting unit 10d sets images of the plurality of things C, D, E, and F respectively as monitoring targets.

In step S411 of the flowchart of FIG. 39, the personal display unit 10c of the monitoring device 10 determines whether access to the baggage monitoring service has been received from the personal terminal 5.

When the baggage monitoring service has not been accessed from the personal terminal 5 in step S411, the personal display unit 10c repeats the operation in step S411.

When it is determined in step S411 that the baggage monitoring service has been accessed, an operation in step S412 is performed. In step S412, the personal display unit 10c determines whether an identification number of the desk 40 has been input to the use screen of the personal terminal 5.

When the identification number has not been input in step S412, the operation in step S412 is repeated.

When it is determined in step S412 that the identification number has been input, an operation in step S413 is performed. In step S413, the target setting unit 10d detects a specified region on the desk 40 in a video photographed by the camera 4 and sets the region in a picture of the camera 4 as a monitoring target.

Thereafter, an operation in step S414 is performed. In step S414, the personal display unit 10c causes the use screen of the personal terminal 5 to display a video of the camera 4 reflecting the desk 40 corresponding to access information.

Thereafter, operations in step S404 and subsequent steps are performed. Steps S404 to S410 are the same as steps S404 to S410 in the flowchart of FIG. 37.

According to the first modification of the fourth embodiment explained above, when receiving input of information for designating any desk 40, the personal terminal 5 transmits the information to the monitoring device 10. The monitoring device 10 detects a specified region in a region on the designated desk 40 and sets the specified region in a picture of the camera 4 as a monitoring target. Alternatively, the monitoring device 10 sets, as a monitoring target, an image of a thing present in the specified region on the designated desk 40. Therefore, the monitoring system 1 can set a target object with simple operation from the user. It is possible to prevent the user from erroneously set a thing of another user as a target object of monitoring.

When the specified region is an entire region on the desk 40, the monitoring device 10 sets, as a monitoring target, the entire region on the desk 40 or images of all things on the desk 40. Therefore, it is possible to improve convenience of the user.

Note that the specified region set on the desk 40 may be any region. For example, the specified region may be a half region of the region on the desk 40.

Note that a pattern indicating the specified region may be provided on the surface of the desk 40. Therefore, the user and an employee of the store 2 can learn a region set as a monitoring target. It is possible to prevent an unintended thing from being set as a target object because the user erroneously puts the thing in the specified region.

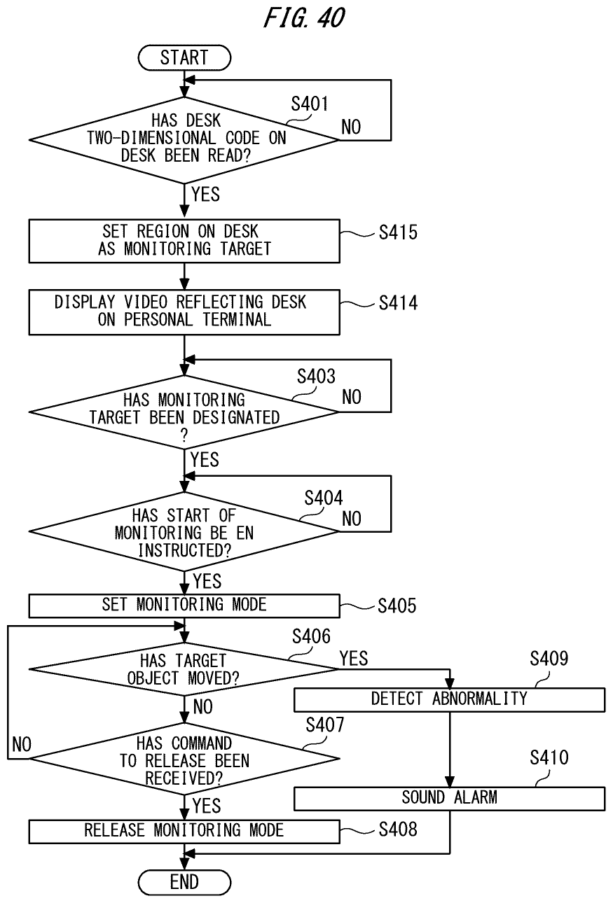

Subsequently, a second modification of the fourth embodiment is explained with reference to FIG. 40.

FIG. 40 is a flowchart for explaining an overview of an operation of the second modification of the monitoring system in the fourth embodiment.

Although not illustrated, in the second modification of the fourth embodiment, not an identification number but the desk two-dimensional code 40a is provided on the desk 40.

The user reads the desk two-dimensional code 40a of the desk 40 with the personal terminal 5. The personal terminal 5 transmits desk access information to the monitoring device 10.

The target setting unit 10d of the monitoring device 10 specifies, based on the desk access information and the desk information stored by the desk database 41, the camera 4 that photographs the desk 40 corresponding to the desk access information. The target setting unit 10d detects a specified region set on the desk 40 and sets the specified region as a monitoring target. At this time, a target object is present on the desk 40.

Note that the target setting unit 10d may set, as a monitoring target, an image of a thing present on the inside of the specified region set on the desk 40 corresponding to the desk access information.

As illustrated in FIG. 40, step S401 is the same as step S401 of the flowchart of FIG. 37.

When it is determined in step S401 that the desk two-dimensional code 40a has been read, an operation in step S415 is performed. In step S415, the personal terminal 5 transmits the desk access information to the monitoring device 10. The target setting unit 10d of the monitoring device 10 specifies the camera 4 that photographs the desk 40 corresponding to the desk access information. The target setting unit 10d sets a specified region on the desk 40 as a monitoring target.

Thereafter, operations in step S414 and subsequent steps are performed. Steps S414 to S410 are the same as steps S414 to S410 in the flowchart of FIG. 39.

According to the second modification of the fourth embodiment explained above, when receiving desk access information, the monitoring device 10 detects a specified region in the region on the desk 40 corresponding to the desk access information and sets the specified region in a picture of the camera 4 as a monitoring target. Alternatively, the monitoring device 10 sets, as a monitoring target, an image of a thing present in the specified region on the designated desk 40. Therefore, the user can easily set a target object. As a result, convenience of the user is improved.

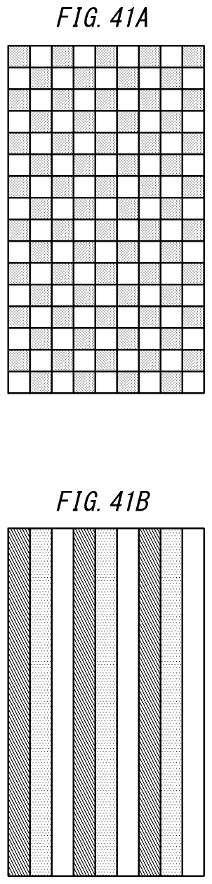

Note that, in the first modification and the second modification of the fourth embodiment, a pattern on the surface of the desk 40 may be a characteristic pattern. The characteristic pattern is a pattern in which colors and patterns are regularly arrayed. FIG. 41 is a diagram illustrating an example of a pattern of a desk of the monitoring system in the fourth embodiment.

(a) of FIG. 41 is a lattice pattern in which two or more colors formed in a square shape are alternately arranged. (b) of FIG. 41 is a stripe pattern in which two or more colors formed in a rectangular shape are arranged.

As explained above, the surface of the desk 40 may have the pattern in which colors and patterns are regularly arrayed. Since the surface of the desk 40 has the pattern illustrated in FIG. 41, the target setting unit 10d and the movement detecting unit 10f of the monitoring device 10 can easily detect an image of a thing on the desk 40 from a video. For example, it is possible to prevent, because a thing on the desk has a similar color or a similar pattern to the surface of the desk, the thing from being omitted from setting of a target object. For example, it is possible to prevent, because a thing on the desk has a similar color or a similar pattern to the surface of the desk, a failure to detect a change in an image of the thing.

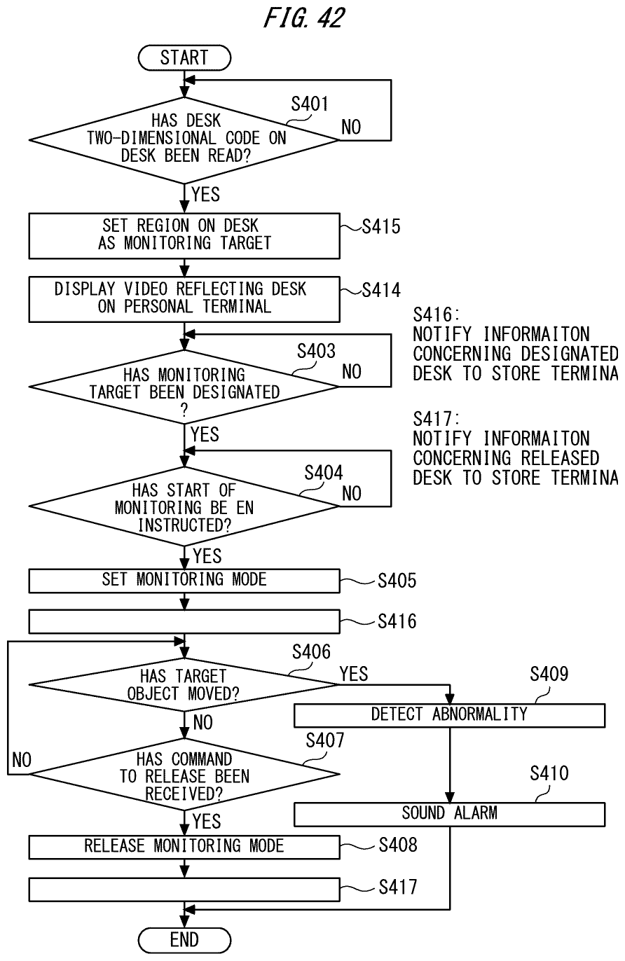

Subsequently, a third modification of the monitoring system 1 in the fourth embodiment is explained with reference to FIG. 42.

FIG. 42 is a flowchart for explaining an overview of an operation of the third modification of the monitoring system in the fourth embodiment.

The third modification of the fourth embodiment is different from the second modification of the fourth embodiment in that the monitoring device 10 notifies the store terminal 3 that a monitoring mode has been set or released.

As illustrated in FIG. 42, steps S401 to S405 are the same as steps S401 to S405 in the flowchart of FIG. 40 in the second modification.

After step S405, an operation in step S416 is performed. In step S416, the store display unit 10b of the monitoring device 10 notifies information concerning the designated desk 40 to the store terminal 3. Specifically, the store display unit 10b causes the store use screen of the store terminal 3 to display identification information of the desk 40 corresponding to desk access information and indication that the monitoring mode has been set in a region on the desk 40.

After step S416, operations in step S406 and subsequent steps are performed. Steps S406 to S410 are the same as steps S406 to S410 in the flowchart of FIG. 40.

After step S408, an operation in step S417 is performed. In step S417, the store display unit 10b notifies, to the store terminal 3, information concerning the desk 40 for which the monitoring mode has been released. Specifically, the store display unit 10b causes the store use screen of the store terminal 3 to display identification information of the desk 40 corresponding to a monitoring target for which the monitoring mode has been released and indication that the monitoring mode has been released. Thereafter, the monitoring system 1 ends the operation.

Note that the third modification of the fourth embodiment may be different not from the second modification of the fourth embodiment but from the first modification of the fourth embodiment in that the monitoring device 10 notifies the store terminal 3 that the monitoring mode has been set or released.

According to the third modification of the fourth embodiment explained above, when a specified region on the desk 40 has been set as a monitoring target, the monitoring device 10 causes the store terminal 3 to display information indicating that a region on the desk 40 has been set as a target object. Therefore, an employee of the store 2 can learn that a thing on the desk 40 has been set as a target object. For example, tableware on the desk 40 is sometimes set as a target object. At this time, it is possible to prevent an alarm from being sounded by a service act of the employee such as an act of the employee putting away the tableware, an act of the employee moving the tableware in order to put other tableware on the desk 40. Note that, when setting an image of a thing present on the inside of the specified region on the desk 40 is set as a monitoring target, the monitoring device 10 may cause the store terminal 3 to display information indicating that the image of the thing on the desk 40 has been set as the monitoring target.

The monitoring device 10 causes the store terminal 3 to display that the monitoring mode has been released. Therefore, the employee can learn that a monitoring mode of a desk corresponding to the monitoring mode has been released.

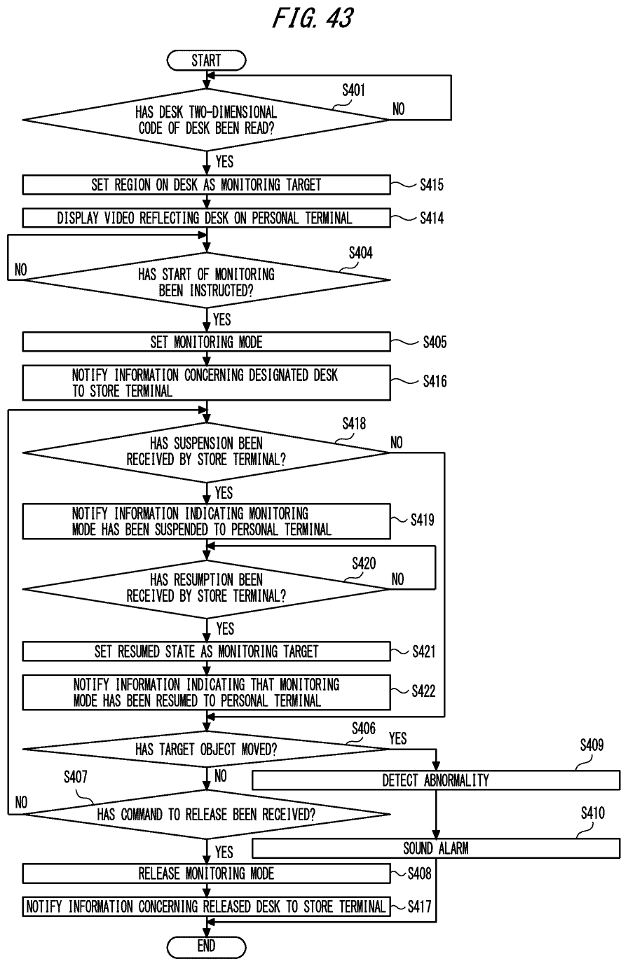

Subsequently, a fourth modification of the monitoring system 1 in the fourth embodiment is explained with reference to FIG. 43.

FIG. 43 is a flowchart for explaining an overview of an operation of the fourth modification of the monitoring system in the fourth embodiment.

The fourth modification of the fourth embodiment is different from the third modification of the fourth embodiment in that the monitoring mode can be suspended and resumed from the store terminal 3. Although not illustrated, the store display unit 10b of the monitoring device 10 receives, from the store terminal 3, a command to suspend the monitoring mode set in a region on a certain desk 40. The store display unit 10b receives, from the store terminal 3, a command to resume the monitoring mode suspended by the command from the store terminal 3. When the monitoring mode has been suspended or resumed by the command from the store terminal 3, the personal display unit 10c of the monitoring device 10 notifies the personal terminal 5 corresponding to the monitoring mode to that effect.

When the monitoring mode has been resumed, the target setting unit 10d of the monitoring device 10 sets, as a monitoring target, anew, a state of the desk 40 at a point in time when the monitoring mode has been resumed. Specifically, the target setting unit 10d acquires a picture of the camera 4 reflecting the desk 40 at the point in time when the monitoring mode has been resumed. The target setting unit 10d sets, as a monitoring target, anew, a specified region on the desk 40 in the image.

Note that, similarly, the target setting unit 10d may set, as a monitoring target, an image of a thing present on the inside of the specified region on the desk 40 at the point in time when the monitoring mode has been resumed.

As illustrated in FIG. 43, steps S401 to S416 of the flowchart are the same as steps S401 to S416 of the flowchart of FIG. 42.

After step S416, an operation in step S418 is performed. In step S418, the store display unit 10b determines whether a command to suspend the monitoring mode has been received on the store use screen of the store terminal 3.

When it is determined in step S418 that the command to suspend the monitoring mode has been received, an operation in step S419 is performed. In step S418, the mode setting unit 10e suspends the monitoring mode for the monitoring target on the desk 40 corresponding to the monitoring mode. The personal display unit 10c notifies, to the personal terminal 5, information indicating that the monitoring mode has been suspended by the store terminal 3. Specifically, the personal display unit 10c causes the use screen of the personal terminal 5 to display the information.

Thereafter, an operation in step S420 is performed. In step S420, the store display unit 10b determines whether resumption of the monitoring mode has been received on the store use screen of the store terminal 3.

When it is not determined in step S420 that the resumption of the monitoring mode has been received, the operation in step S420 is repeated.

When it is determined in step S420 that the resumption of the monitoring mode has been received, an operation in step S421 is performed. In step S421, the mode setting unit 10e resumes the suspended monitoring mode. The target setting unit 10d sets, as a monitoring target, a state of the desk 40 at a point in time when the monitoring mode has been resumed.

Thereafter, an operation in step S422 is performed. In step S422, the personal display unit 10c notifies, to the personal terminal 5, information indicating that the monitoring mode has been resumed.

After step S422 or when it is not determined in step S418 that the command to suspend the monitoring mode has been received, the operation in step S406 is performed. Step S406 is the same as step S406 of the flowchart of FIG. 42.

When it is determined in step S406 that the position of the target object has not moved, the operation in step S407 is performed. Step S407 is the same as step S407 of the flowchart of FIG. 42.

When it is determined in step S407 that release of the monitoring mode has not been received from the personal terminal 5, operations in step S418 and subsequent steps are performed.

When it is determined in step S407 that the release of the monitoring mode has been received from the personal terminal 5, operations in step S408 and subsequent steps are performed. Steps S408 to S417 are the same as steps S408 to S417 of the flowchart of FIG. 42.

When it is determined in step S406 that the position of the target object has moved, operations in step S409 and subsequent steps are performed. Steps S409 and S410 are the same as steps S409 and S410 of the flowchart of FIG. 42.

According to the fourth modification of the fourth embodiment explained above, the monitoring device 10 receives, from the store terminal 3, a command to suspend or command to resume the monitoring mode set for a monitoring target on the desk 40. The monitoring device 10 suspends or resumes the monitoring mode corresponding to the target object based on the command to suspend or the command to resume the monitoring mode. Therefore, when performing a service act for a certain desk 40, an employee of the store can suspend the monitoring mode corresponding to a thing on the desk 40. Therefore, it is possible to prevent sounding of an alarm due to the service act of the employee.

When the monitoring mode has been resumed, the monitoring device 10 sets, anew, a state on the desk 40 at that point in time as a target object of monitoring. When a target object on the desk 40 has moved during the suspension of the monitoring mode, an image of the desk 40 reflected by the camera 4 is different before and after the resumption of the monitoring mode. In this case, the monitoring device 10 can detect an abnormality. By setting a monitoring target anew, it is possible to prevent the monitoring device 10 from detecting an abnormality because of a change during the suspension.

When receiving a command to suspend the monitoring mode or a command to resume the monitoring mode, the monitoring device 10 notifies the personal terminal 5 corresponding to the monitoring target to that effect. Therefore, the user can learn the suspension and the resumption of the monitoring mode.

### Fifth Embodiment

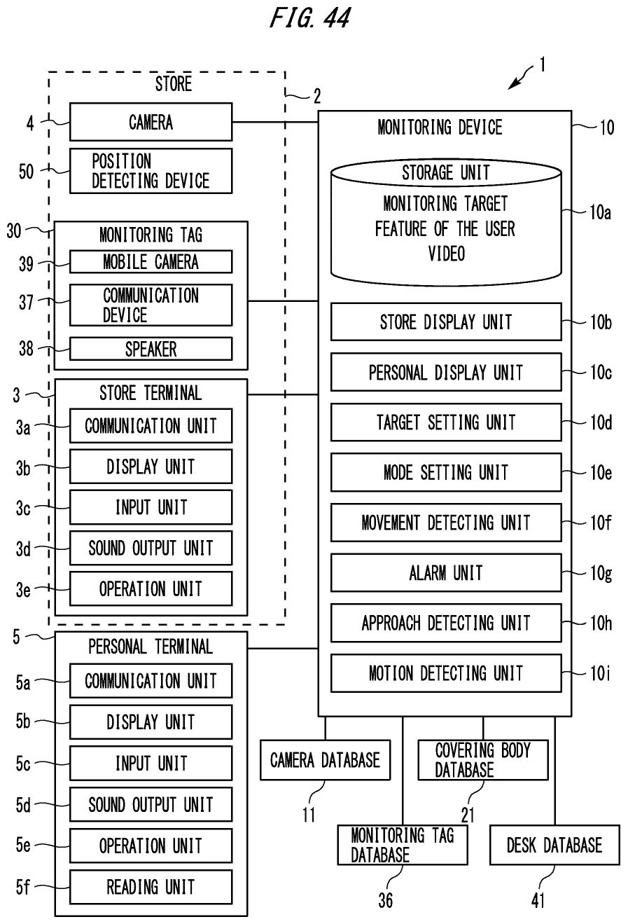

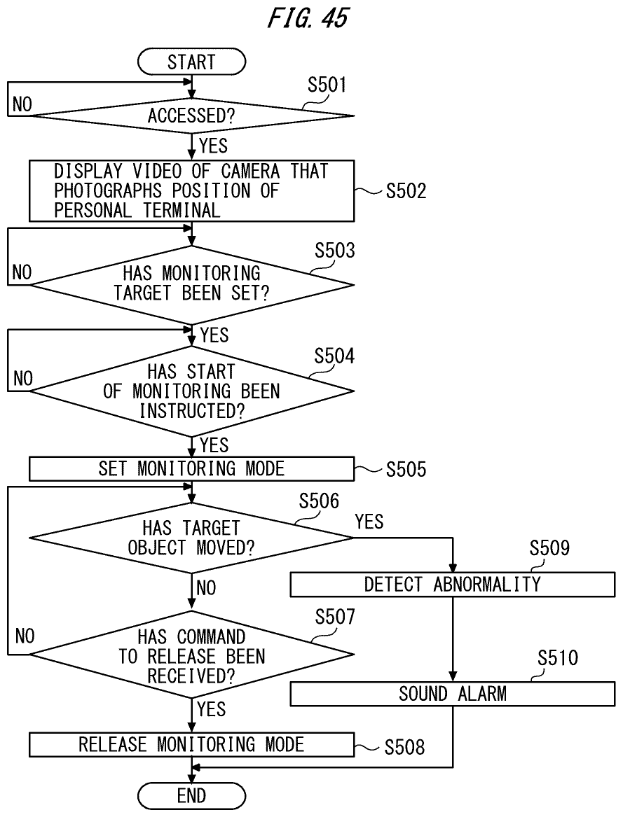

FIG. 44 is a block diagram of a monitoring system in a fifth embodiment. FIG. 45 is a flowchart for explaining an overview of an operation of the monitoring system in the fifth embodiment. Note that portions that are the same as or equivalent to the portions in any one of the first to fourth embodiments are denoted by the same reference numerals and signs. Explanation of the portions is omitted.

As illustrated in FIG. 44, the monitoring system 1 further includes a position detecting device 50.

The position detecting device 50 is provided on the inside of the store 2. The position detecting device 50 detects the position of the personal terminal 5 present on the inside of the store 2 using a radio wave transmitted from the personal terminal 5. For example, the position detecting device 50 is a beacon device that uses BLE [Bluetooth Low Energy (registered trademark)]. In this case, the position detecting device 50 can accurately detect the position of the personal terminal 5 by using the BLE.

When detecting the position of the personal terminal 5, the position detecting device 50 creates position information of the personal terminal 5 in the store 2. The position detecting device 50 transmits the position information of the personal terminal 5 to the monitoring device 10 via a network.

The communication unit 5a of the personal terminal 5 transmits a radio wave corresponding to the radio wave used for the detection of the position of the personal terminal 5 by the position detecting device 50.

In the monitoring device 10, when receiving the position information of the personal terminal 5 from the position detecting device 50, the personal display unit 10c specifies, based on the information stored by the camera database 11, the camera 4 that photographs a position where the personal terminal 5 is present. The personal display unit 10c causes the use screen of the personal terminal 5 to display a video of the specified camera 4.

When receiving the position information of the personal terminal 5 from the position detecting device 50, the target setting unit 10d estimates, based on a video photographed by the camera 4, a position of a thing present around the personal terminal 5. The monitoring device 10 calculates, based on the position information of the personal terminal 5 and the estimated position of the thing, a distance between the personal terminal 5 and the thing. The target setting unit 10d can set, as a target object corresponding to the personal terminal 5, only a thing present within a specified first distance from the personal terminal 5. That is, the target setting unit 10d does not set, as a monitoring target corresponding to the personal terminal 5, an image of a thing present in a position apart from the personal terminal 5 more than the specified first distance or a region of a picture including the image of the thing.

An operation performed in step S501 in the flowchart of FIG. 45 is the same as the operation performed in step S301 in the flowchart of FIG. 25 in the third embodiment.

When it is determined in step S501 that the baggage monitoring service has been accessed from the personal terminal 5, an operation in step S502 is performed. In step S502, the personal display unit 10c of the monitoring device 10 specifies the camera 4 that photographs a position where the personal terminal 5 is present. The personal display unit 10c causes the use screen of the personal terminal 5 to display a video of the specified camera 4.

Thereafter, an operation in step S503 is performed. In step S503, the target setting unit 10d determines whether, in the personal terminal 5, an image of a thing present within the specified first distance from the personal terminal 5 or a region of a picture including the image of the thing has been set as a monitoring target.

When a monitoring target has not been set in step S503, the operation in step S503 is repeated.

When a monitoring target has been set in step S503, operations in step S504 and subsequent steps are performed. Operations performed in steps S504 to S510 are the same as the operations performed in steps S305 to S311 in the flowchart of FIG. 25.

According to the fifth embodiment explained above, the monitoring system 1 includes the position detecting device 50. The position detecting device 50 detects the position of the personal terminal 5. The position detecting device 50 transmits position information of the personal terminal 5 to the monitoring device 10. The monitoring device 10 does not set, based on the position information of the personal terminal 5, as a monitoring target, an image of a thing present in a position apart from the personal terminal 5 more than the specified first distance. The monitoring device 10 does not set, based on the position information of the personal terminal 5, as a monitoring target, a region of a picture including the image of the thing present in the position apart from the personal terminal 5 more than the specified first distance. Therefore, it is possible to prevent the user from erroneously setting a thing of another person as a target object.

The monitoring device 10 causes, based on the position information of the personal terminal 5, the personal terminal 5 to display a video of the camera 4 reflecting the personal terminal 5. Therefore, the user can easily access a video of the camera 4 that photographs the user. As a result, it is possible to improve comfortableness of a user interface on the use screen.

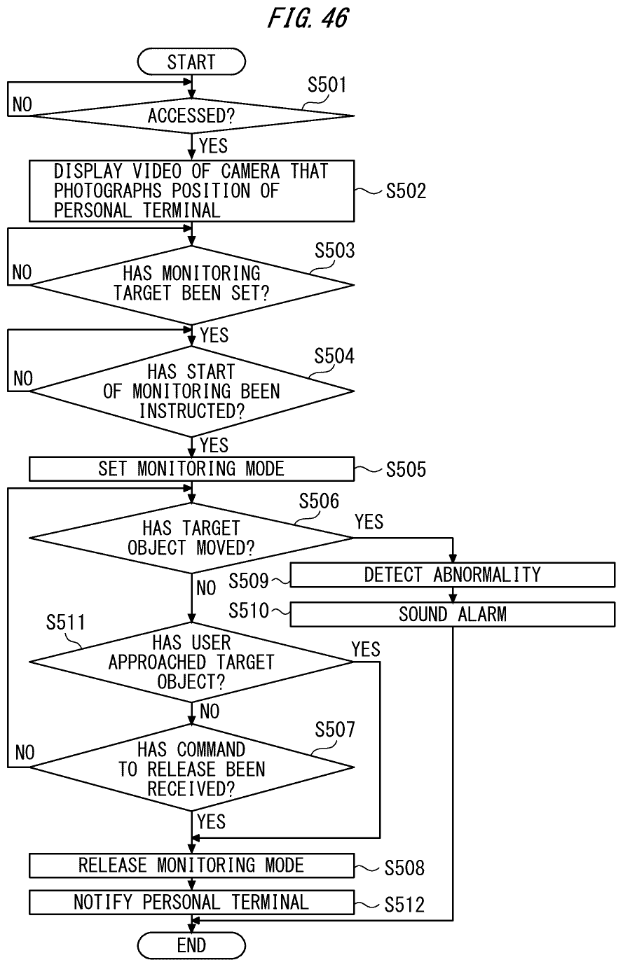

Subsequently, a modification of the monitoring system 1 in the fifth embodiment is explained with reference to FIG. 46.

FIG. 46 is a flowchart for explaining an overview of an operation of the modification of the monitoring system in the fifth embodiment.

In the monitoring device 10 in the modification of the fifth embodiment, when position information of the personal terminal 5 is received from the position detecting device 50 when the monitoring mode is set, the target setting unit 10d calculates a distance between the personal terminal 5 and a target object. When the monitoring mode is set, the target setting unit 10d determines whether the distance between the personal terminal 5 and the target object is within a specified second distance.

When it is determined by the target setting unit 10d that the distance between the personal terminal 5 and the target object is within the specified second distance when the monitoring mode is set, the mode setting unit 10e releases the monitoring mode set in the target object. The mode setting unit 10e notifies the personal terminal 5 that the monitoring mode has been released. Note that not the mode setting unit 10e but the personal display unit 10c may notify the personal terminal 5 that the monitoring mode has been released.

Steps S501 to S506 in the flowchart of FIG. 46 are the same as steps S501 to 506 in FIG. 45 in the fifth embodiment.

When it is determined in step S506 that the target object has moved, operations in step S509 and subsequent steps are performed. Steps S509 and S510 are the same as steps S509 and S510 in FIG. 45.

When it is not determined in step S506 that the target object has moved, an operation in step S511 is performed. In step S511, the target setting unit 10d determines whether the user has approached the target object. Specifically, the target setting unit 10d determines whether the distance between the personal terminal 5 and the target object is within the specified second distance.

When it is determined in step S511 that the distance between the personal terminal 5 and the target object is larger than the second distance, the operation in step S507 is performed. Step S507 is the same as step S507 of the flowchart of FIG. 45.

When it is determined in step S511 that the distance between the personal terminal 5 and the target object is within the second distance, an operation in step S508 is performed. In step S508, the mode setting unit 10e releases the monitoring mode set for the target object.

After step S508, an operation in step S512 is performed. In step S512, the mode setting unit 10e notifies the personal terminal 5 that the monitoring mode has been released. Thereafter, the monitoring system 1 ends the operation.

According to the modification of the fifth embodiment explained above, when determining, based on the position information of the personal terminal 5, that the distance between the personal terminal 5 and the target object is smaller than the specified second distance, the monitoring device 10 releases the monitoring mode of the target object. That is, when the user approaches the target object, the monitoring mode is automatically released. Therefore, convenience of the user is improved. It is possible to prevent an alarm from being sounded because the user forgets to release the monitoring mode.

### Sixth Embodiment

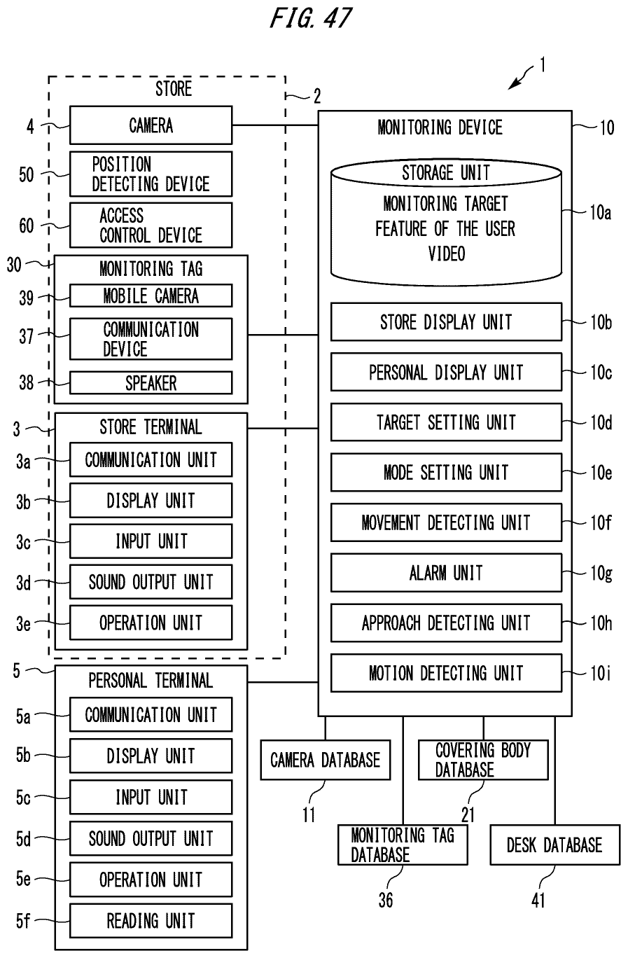

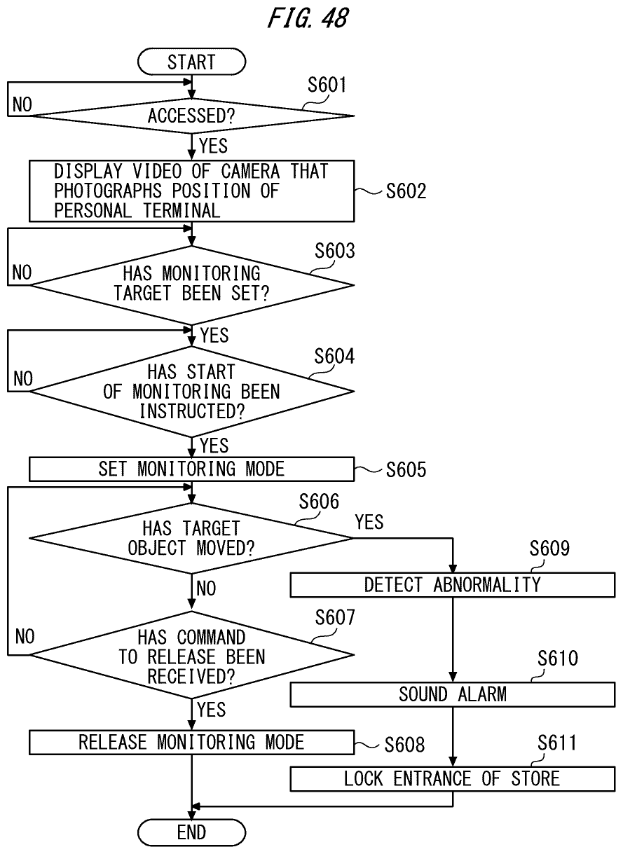

FIG. 47 is a block diagram of a monitoring system in a sixth embodiment. FIG. 48 is a flowchart for explaining an overview of an operation of the monitoring system in the sixth embodiment. Note that portions that are the same as or equivalent to the portions in any one of the first to fifth embodiments are denoted by the same reference numerals and signs. Explanation of the portions is omitted.

As illustrated in FIG. 47, in the sixth embodiment, the monitoring system 1 further includes an access control device 60.

The access control device 60 is provided in the store 2. The access control device 60 can communicate with the monitoring device 10 via a network. The access control device 60 controls locking and unlocking of the entrance of the store 2. Specifically, the entrance of the store 2 is an entrance and exit door of the store 2, an automatic door of the store 2, or the like.

When causing the store terminal 3 and the personal terminal 5 to sound an alarm, the alarm unit 10g of the monitoring device 10 transmits a command to lock the entrance of the store 2 to the access control device 60.

Operations performed in steps S601 to S605 of the flowchart of FIG. 48 are the same as the operations performed in steps S101 to S105 of FIG. 4 in the first embodiment. Operations performed in steps S606 to S610 are the same as the operations in steps S306 to S311 in FIG. 25 in the third embodiment.

After the operation in step S610 has been performed, an operation in step S611 is performed. In step S611, the alarm unit 10g transmits a command to lock the entrance to the access control device 60. The access control device 60 locks the entrance of the store 2 based on the command from the monitoring device 10. Thereafter, the monitoring system 1 ends the operation.

According to the sixth embodiment explained above, the monitoring system 1 includes the access control device 60. When sounding an alarm, the monitoring device 10 causes the access control device 60 to lock the entrance of the store. Therefore, when a target object is stolen, it is possible to prevent a suspect of the theft from running away. As a result, it is possible to improve a suspect arrest rate of crimes such as luggage lifting.

### Seventh Embodiment

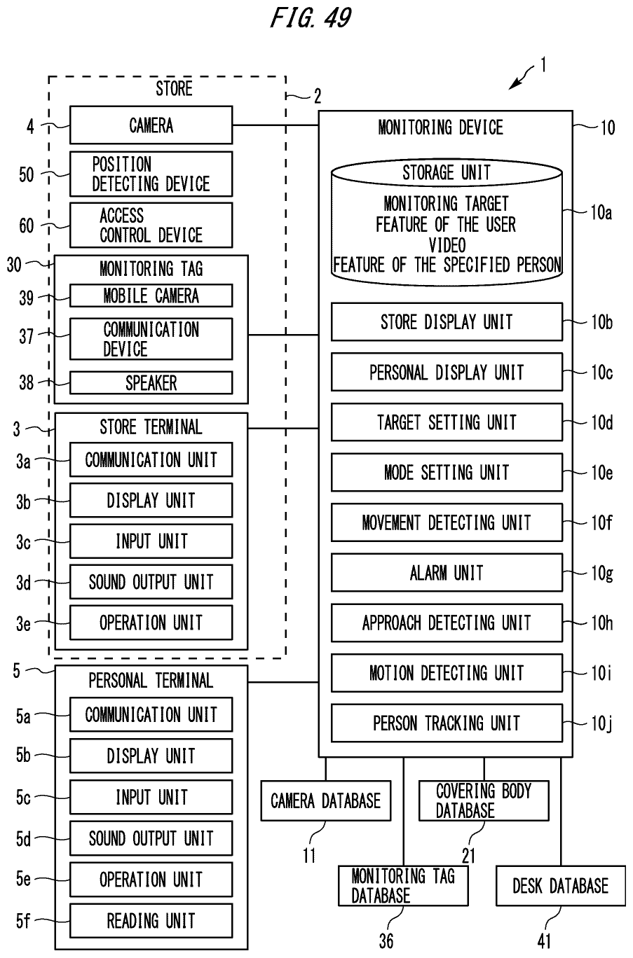

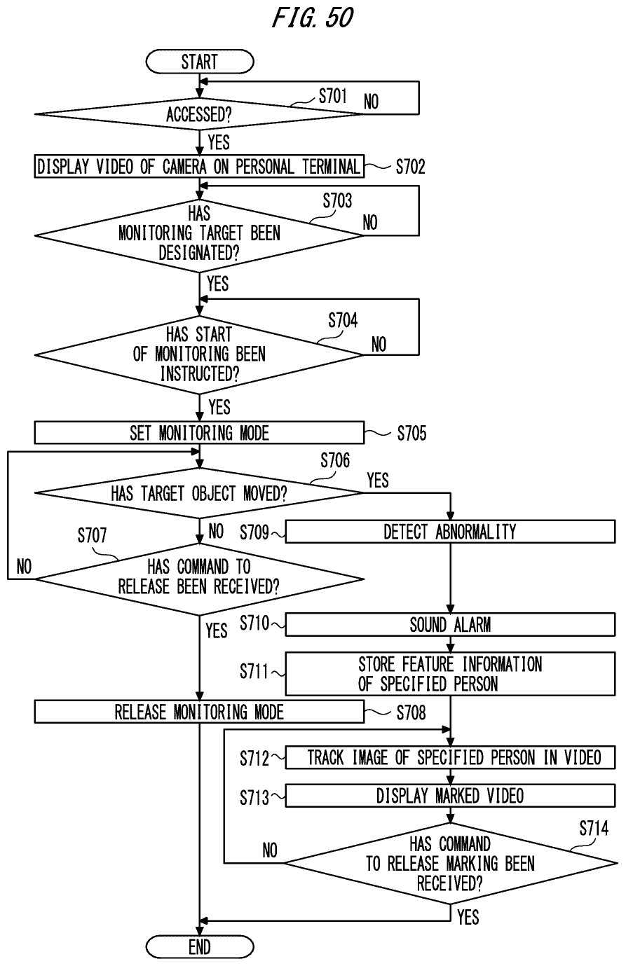

FIG. 49 is a block diagram of a monitoring system in a seventh embodiment. FIG. 50 is a flowchart for explaining an overview of an operation of the monitoring system in the seventh embodiment. Note that portions that are the same as or equivalent to the portions in any one of the first to sixth embodiments are denoted by the same reference numerals and signs. Explanation of the portions is omitted.

As illustrated in FIG. 49, in the seventh embodiment, the monitoring device 10 includes a person tracking unit 10j.

When the alarm unit 10g causes the store terminal 3 and the personal terminal 5 to sound an alarm, the person tracking unit 10j specifies, as a specified person, a person closest to a target object in a video of the camera 4 that photographs the target object. Alternatively, when a region of a picture is set as a monitoring target, the person tracking unit 10j specifies, as a specified person, a person at the shortest distance on the picture from the center of the region of the picture. The person tracking unit 10j causes the storage unit 10a to store feature information of the specified person. For example, the feature information of the specified person is exterior features such as height and clothes of the specified person. The person tracking unit 10j tracks an image of the specified person in a video of the camera 4. Specifically, the person tracking unit 10j marks the image of the specified person in the video of the camera 4. At this time, the person tracking unit 10j may mark images of the specified person in videos of the plurality of cameras 4.

When the person tracking unit 10j has specified the specified person, the store display unit 10b causes the store use screen of the store terminal 3 to display the video of the camera 4 in which the specified person is marked. The store display unit 10b receives, on the store use screen, from the store terminal 3, a command to release the marking of the specified person.

When the person tracking unit 10j has specified the specified person, the personal display unit 10c causes the use screen of the personal terminal 5 to display the video of the camera 4 in which the specified person is marked. The personal display unit 10c receives, on the use screen, from the personal terminal 5, a command to release the marking of the specified person.

Operations performed in steps S701 to S710 of the flowchart of FIG. 50 are the same as the operations performed in steps S601 to S610 in FIG. 48 in the sixth embodiment.

After the operation in step S710 has been performed, an operation in step S711 is performed. In step S711, the person tracking unit 10j of the monitoring device 10 specifies the specified person. The person tracking unit 10j causes the storage unit 10a to store the feature information of the specified person.

Thereafter, an operation in step S712 is performed. In step S712, the person tracking unit 10j tracks an image of the specified person in a video of the camera 4.

Thereafter, an operation in step S713 is performed. In step S713, the store display unit 10b causes the store use screen of the store terminal 3 to display a video of the camera 4 in which the specified person is marked. The personal display unit 10c causes the use screen of the personal terminal 5 to display a video of the camera 4 in which the specified person is marked.

Thereafter, an operation in step S714 is performed. In step S714, the person tracking unit 10j determines whether a command to release the marking has been received from the store terminal 3 or the personal terminal 5.

When it is determined in step S714 that the command to release the marking has not been received, the operations in step S712 and subsequent steps are repeated.

When receiving the command to release the marking has been received in step S417, the person tracking unit 10j releases the marking of the specified person. Thereafter, the monitoring system 1 ends the operation.

According to the seventh embodiment explained above, the monitoring device 10 includes the person tracking unit 10j. When detecting an abnormality, the monitoring device 10 specifies a person closest to the target object as a specified person. The monitoring device 10 causes the store terminal 3 and the personal terminal 5 to display a video indicating the specified person. Therefore, when an alarm is sounded, the employee of the store 2 and the user can learn the specified person who is a cause of the alarm. For example, when a target object is stolen, a suspect of the theft can be easily found. As a result, it is possible to improve a suspect arrest rate of crimes such as luggage lifting.

### INDUSTRIAL APPLICABILITY

As explained above, the monitoring device, the monitoring system, the program, and the monitoring method according to the present disclosure can be used in a security system of a store.

### REFERENCE SIGNS LIST

1 System
2 Store
3 Store terminal
3a Communication unit
3b Display unit
3c Input unit
3d Sound output unit
3e Operation unit
4, 4a, 4b Camera
5 Personal terminal
5a Communication unit
5b Display unit
5c Input unit
5d Sound output unit
5e Operation unit
5f Reading unit
5g Wireless communication unit
6 Posting body
6a Posting two-dimensional code
10 Monitoring device
10a Storage unit
10b Store display unit
10c Personal display unit
10d Target setting unit
10e Mode setting unit
10f Movement detecting unit
10g Alarm unit
10h Approach detecting unit
10i Motion detecting unit
10j Person tracking unit
11 Camera database
20 Covering body
20a Covering body two-dimensional code
21 Covering body database
30, 30a, 30b, 30c, 30d, 30e Monitoring tag
31 Tag two-dimensional code
32d Light source
33e First light source
34e Second light source
35e Third light source
36 Monitoring tag database
37, 37c, 37d Communication device
38, 38c, 38d Speaker
39 Mobile camera
40 Desk
40a Desk two-dimensional code
41 Desk database
50 Position detecting device
60 Access control device
100a Processor
100b Memory
200 Hardware

1. A monitoring device that receives, from a camera provided in a store, a video of the store, which is continuous pictures photographed by the camera, and communicates with a personal terminal carried by a user of the store, the monitoring device comprising:
processing circuitry
to set, based on a command from the personal terminal to start monitoring, a monitoring mode for watching a thing;
to set, as a monitoring target, an image of a target object of monitoring designated from the personal terminal among the pictures photographed by the camera or a region of a picture reflecting the target object of monitoring among the pictures photographed by the camera, the region being a region of a picture designated from the personal terminal of the user;
to, when the monitoring mode is set by the processing circuitry, detect an abnormality when it is detected that the target object reflected in the video photographed by the camera has moved; and
to, when receiving a command to display the monitoring target from a store terminal provided in the store when the monitoring mode is set, cause the store terminal to display the video of the camera that photographs the monitoring target.

2.-claim 71. (canceled)

72. The monitoring device according to claim 1, wherein the processing circuitry is configured
to cause the personal terminal to display, as a use screen, the video photographed by the camera, and
to, when receiving a command to display the monitoring target from the personal terminal when the monitoring mode is set, cause the personal terminal to display the video of the camera that photographs the monitoring target.

73. The monitoring device according to claim 72, wherein the processing circuitry is configured to cause the personal terminal to display, as a use screen, the video photographed by the camera and receive, on the use screen, designation of the target object or designation of the region of the picture, as the monitoring target.

74. The monitoring device according to claim 1, wherein the processing circuitry is configured to, when the image of the target object or an image of the region of the picture has changed, detect that the target object has moved.

75. The monitoring device according to claim 1, wherein the processing circuitry is configured to, when the processing circuitry has detected an abnormality, and to cause the personal terminal and a store terminal provided in the store to sound an alarm.

76. The monitoring device according to claim 75, wherein the processing circuitry is configured
to store information, and
to, when causing the personal terminal and the store terminal to sound the alarm, to store a video or a picture of the camera that is photographing the monitoring target.

77. The monitoring device according to claim 72, wherein the processing circuitry is configured
to, when the processing circuitry has detected an abnormality, cause the personal terminal and a store terminal provided in the store to sound an alarm,
to, when the processing circuitry causes the personal terminal and the store terminal to sound the alarm, specify, as a specified person, a person closest to the target object reflected in the video photographed by the camera and to track an image of the specified person in the video photographed by the camera,
to, when the processing circuitry has specified the specified person, cause the personal terminal to display a video of the camera in which the specified person is marked, and
to, when the processing circuitry has specified the specified person, cause the store terminal to display the video of the camera in which the specified person is marked.

78. The monitoring device according to claim 1, wherein the processing circuitry is configured
to, when the processing circuitry has detected an abnormality, cause the personal terminal and a store terminal provided in the store to sound an alarm; and
to, when the processing circuitry cause the personal terminal and the store terminal to sound the alarm, specify, as a specified person, a person closest to the target object reflected in the video photographed by the camera and to track an image of the specified person in the video photographed by the camera.

79. The monitoring device according to claim 1, wherein the processing circuitry is configured to detect a registered covering body from the video photographed by the camera, to set, as the target object of monitoring, the covering body designated from the personal terminal of the user, and to set, as the monitoring target, an image of the covering body in the video photographed by the camera or a region of a picture including the image of the covering body.

80. The monitoring device according to claim 79, wherein the processing circuitry is configured to, when receiving covering body access information for identifying the covering body from the personal terminal, set, as the target object of monitoring, the covering body indicated by the covering body access information and to set, as the monitoring target, the image of the covering body in the video photographed by the camera or the region of the picture including the image of the covering body.

81. The monitoring device according to claim 72, wherein the processing circuitry is configured to, when receiving desk access information for identifying any desk among a plurality of desks provided in the store from the personal terminal, detect a specified region in a region on the desk indicated by the desk access information and to set, as the monitoring target, the specified region including an image of the target object in a picture of the camera.

82. The monitoring device according to claim 72, wherein the processing circuitry is configured to, when receiving desk access information for identifying any desk among a plurality of desks provided in the store from the personal terminal, set, as the target object, a thing present on an inside of a specified region in a region on the desk indicated by the desk access information and to set, as the monitoring target, an image of a thing present on the inside of the specified region in a picture of the camera.

83. The monitoring device according to claim 81, wherein the specified region is an entire region on the designated desk.

84. The monitoring device according to claim 72, wherein the processing circuitry is configured
to, when receiving desk access information for identifying any desk among a plurality of desks provided in the store from the personal terminal, detect a specified region in a region on the desk indicated by the desk access information and to set, as the monitoring target, the specified region including the target object in a picture of the camera, and
to, after the processing circuitry has set the specified region as the monitoring target, when the processing circuitry has set the monitoring mode, cause the store terminal to display identification information of the designated desk and indication that the monitoring mode for the specified region has been set.

85. The monitoring device according to claim 72, wherein the processing circuitry is configured
to, when receiving desk access information for identifying any desk among a plurality of desks provided in the store from the personal terminal, set, as the target object, a thing present on an inside of a specified region in a region on the desk indicated by the desk access information and to set, as the monitoring target, an image of the thing present on the inside of the specified region in a picture of the camera, and
to, after the processing circuitry has set, as the monitoring target, the image of the thing present on the inside of the specified region, when the processing circuitry has set the monitoring mode, cause the store terminal to display identification information of the desk indicated by the desk access information and indication that the thing present on the inside of the specified region has been set as the target object.

86. The monitoring device according to claim 84, wherein the processing circuitry is configured
to, when receiving a command to release from the personal terminal when the monitoring mode is set, release the monitoring mode, and
to, when the processing circuitry has released the monitoring mode, cause the store terminal to display that the monitoring mode has been released.

87. The monitoring device according to claim 1, wherein the processing circuitry is configured not to, when receiving information indicating a position of the personal terminal on an inside of the store, set, based on the information indicating the position of the personal terminal and a video photographed by the camera, as the monitoring target, an image of a thing present in a position apart from the personal terminal more than a specified first distance or a region of a picture including the image of the thing present in the position apart from the personal terminal more than the specified first distance.

88. The monitoring device according to claim 72, wherein the processing circuitry is configured to, when receiving information indicating a position of the personal terminal on an inside of the store, cause, based on the information indicating the position of the personal terminal, the personal terminal to display a video of the camera that photographs the position of the personal terminal.

89. The monitoring device according to claim 1, wherein the processing circuitry is configured
to, when receiving information indicating a position of the personal terminal on an inside of the store, determine, based on the information indicating the position of the personal terminal and a video photographed by the camera, whether a distance between the personal terminal and the target object is shorter than a specified second distance, and
to, when the processing circuitry determines that the distance between the personal terminal and the target object is shorter than the second distance when the monitoring mode is set, release the monitoring mode.

90. The monitoring device according to claim 75, wherein the processing circuitry is configured to, when causing the personal terminal and the store terminal provided in the store to sound the alarm, transmit, to a device that controls locking and unlocking of an entrance provided in the store, a command to lock the entrance provided in the store.

91. A monitoring system comprising:
a camera provided in a store;
a personal terminal carried by a user of the store;
a monitoring device that receives a video of the store, which is continuous pictures photographed by the camera, and communicates with the personal terminal; and
a store terminal provided in the store, wherein
the monitoring device sets, based on a command from the personal terminal to start monitoring, a monitoring mode for watching a thing, sets, as a monitoring target, an image of a target object of monitoring designated from the personal terminal among the pictures photographed by the camera or a region of a picture reflecting the target object of monitoring among the pictures photographed by the camera, the region being a region of a picture designated from the personal terminal of the user, and, when the monitoring mode is set, detects an abnormality when it is detected that the target object reflected in the video photographed by the camera has moved, and, when receiving a command to display the target object from the store terminal when the monitoring mode is set, causes the store terminal to display the video of the camera that photographs the target object.

92. The monitoring system according to claim 91, wherein
the monitoring device detects that the target object has moved when the image of the target object or an image of the region of the picture has changed and causes the personal terminal and the store terminal to sound an alarm when an abnormality is detected.

93. The monitoring system according to claim 91, wherein the monitoring device causes the personal terminal to display, as a use screen, the video photographed by the camera, receives designation of the target object or designation of the region of the picture on the use screen, when receiving a command to display the target object from the personal terminal when the monitoring mode is set, causes the personal terminal to display a video of the camera that photographs the target object.

94. The monitoring system comprising:
a camera provided in a store;
a personal terminal carried by a user of the store;
a monitoring device that receives a video of the store, which is continuous pictures photographed by the camera, and communicates with the personal terminal; and
a posting body provided in the store and indicating that the monitoring device is performing a baggage monitoring service for watching a thing carried by the user, wherein
the monitoring device sets, based on a command from the personal terminal to start monitoring, a monitoring mode for watching a thing, sets, as a monitoring target, an image of a target object of monitoring designated from the personal terminal among the pictures photographed by the camera or a region of a picture reflecting the target object of monitoring among the pictures photographed by the camera, the region being a region of a picture designated from the personal terminal of the user, and, when the monitoring mode is set, detects an abnormality when it is detected that the target object reflected in the video photographed by the camera has moved.

95. The monitoring system according to claim 94, wherein
the posting body includes a posting two-dimensional code indicating access information for accessing the monitoring device, and
when a picture reflecting an image of the posting two-dimensional code has been photographed, the personal terminal reads the access information from the image of the posting two-dimensional code reflected in the picture and accesses a use screen of the monitoring device based on the access information.

96. The monitoring system according to claim 91, further comprising a covering body placed to cover a thing that the user desires to monitor in the store, wherein
the monitoring device detects a registered covering body from the video photographed by the camera and, when receiving a command from the personal terminal of the user, sets the covering body as the target object of monitoring and sets, as the monitoring target, an image of the covering body in the video photographed by the camera or a region of a picture including the image of the covering body.

97. The monitoring system according to claim 96, wherein the covering body has an identifiable specific pattern.

98. The monitoring system according to claim 96, wherein
the covering body has a covering body two-dimensional code indicating covering body access information with which information for accessing the monitoring device and identification information of the covering body are associated,
when a picture reflecting an image of the covering body two-dimensional code has been photographed, the personal terminal reads the covering body access information from the image of the covering body two-dimensional code reflected in the picture and accesses a use screen of the monitoring device based on the covering body access information and transmits the covering body access information to the monitoring device, and
when receiving the covering body access information from the personal terminal, the monitoring device sets, as the target object of monitoring, the covering body indicated by the covering body access information and sets, as the monitoring target, an image of the covering body in the video photographed by the camera or a region of a picture including the image of the covering body.

99. The monitoring system according to claim 91, further comprising a plurality of desks provided in the store, each of the plurality of desks having a desk two-dimensional code indicating desk access information with which information for accessing the monitoring device and identification information are associated, wherein
when a picture reflecting an image of the desk two-dimensional code has been photographed, the personal terminal reads the desk access information from the image of the desk two-dimensional code reflected in the picture and accesses a use screen of the monitoring device based on the desk access information and transmits the desk access information to the monitoring device, and
when receiving, from the personal terminal, the desk access information for identifying any desk among the plurality of desks provided in the store, the monitoring device detects a specified region in a region on the desk indicated by the desk access information and sets, as the monitoring target, the specified region including an image of the target object in a picture of the camera.

100. The monitoring system according to claim 91, further comprising a position detecting device that specifies a position of the personal terminal with a radio wave, creates information indicating a position of the personal terminal on an inside of the store, and transmits the information to the monitoring device, wherein
when receiving, from the position detecting device, the information indicating the position of the personal terminal on the inside of the store, the monitoring device does not set, based on the information indicating the position of the personal terminal and the video photographed by the camera, as the monitoring target, an image of a thing present in a position apart from the personal terminal more than a specified first distance or a region of a picture including the image of the thing present in the position apart from the personal terminal more than the specified first distance.

101. The monitoring system according to claim 91, further comprising a position detecting device that specifies a position of the personal terminal with a radio wave, creates information indicating a position of the personal terminal on an inside of the store, and transmits the information to the monitoring device, wherein
when receiving, from the position detecting device, the information indicating the position of the personal terminal on the inside of the store, the monitoring device causes, based on the information indicating the position of the personal terminal, the personal terminal to display a video of the camera that photographs the position of the personal terminal.

102. The monitoring system according to claim 91, further comprising a position detecting device that specifies a position of the personal terminal with a radio wave, creates information indicating a position of the personal terminal on an inside of the store, and transmits the information to the monitoring device, wherein
when receiving, from the position detecting device, the information indicating the position of the personal terminal on the inside of the store, the monitoring device determines, based on the information indicating the position of the personal terminal and the video photographed by the camera, whether a distance between the personal terminal and the target object is shorter than a specified distance and, when determining that the distance between the personal terminal and the target object is shorter than a specified second distance when the monitoring mode is set, releases the monitoring mode.

103. The monitoring system according to claim 91, further comprising an access control device that controls locking and unlocking of an entrance provided in the store, wherein
when causing the personal terminal and the store terminal provided in the store to sound an alarm, the monitoring device transmits, to the access control device, a command to lock the entrance provided in the store.

104. A storage medium storing a program for causing a computer, which receives, from a camera provided in a store, a video of the store, which is continuous pictures photographed by the camera, and communicates with a personal terminal carried by a user of the store, to execute:
setting, based on a command from the personal terminal to start monitoring, a monitoring mode for watching a thing;
setting, as a monitoring target, an image of a target object of monitoring designated from the personal terminal among the pictures photographed by the camera or a region of a picture reflecting the target object of monitoring among the pictures photographed by the camera, the region being a region of a picture designated from the personal terminal of the user;
when the monitoring mode is set, detecting an abnormality when it is detected that the target object reflected in the video photographed by the camera has moved; and
when receiving a command to display the monitoring target from a store terminal provided in the store when the monitoring mode is set, causing the store terminal to display the video of the camera that photographs the monitoring target.

105. A monitoring method comprising:
setting, based on a command from a personal terminal carried by a user of a store to start monitoring, a monitoring mode for watching a thing;
setting, as a monitoring target, an image of a target object of monitoring designated from the personal terminal among the pictures photographed by a camera provided in the store or a region of a picture reflecting the target object of monitoring among the pictures photographed by the camera, the region being a region of a picture designated from the personal terminal of the user;
performed after, when the monitoring mode is set, detecting an abnormality when it is detected that the target object reflected in the video photographed by the camera has moved; and
when receiving a command to display the monitoring target from a store terminal provided in the store when the monitoring mode is set, causing the store terminal to display the video of the camera that photographs the monitoring target.
